(19) United States
(12) Patent Application Publication
(10) Pub. No.: US 2026/0222902 A1
(43) Pub. Date: Jul. 30, 2026

(54) BUFFER STATUS REPORTING FOR A SUBSET OF LOGICAL CHANNELS

(71) Applicant: Lenovo (Singapore) Pte. Ltd., Singapore (SG)

(72) Inventors: Joachim Löhr, Wiesbaden (DE); Prateek Basu Mallick, Dreieich (DE); Hyung-Nam Choi, Ottobrunn (DE); Ravi Kuchibhotla, Chicago, IL (US)

(21) Appl. No.: 19/142,146

(22) PCT Filed: Dec. 26, 2023
(86) PCT No.: PCT/IB2023/063250

§ 371 Date: Jun. 20, 2025

Related U.S. Application Data
(60) Provisional application No. 63/435,181, filed on Dec. 23, 2022.

(51) Int. Cl. H04W 28/02

(52) U.S. Cl. CPC H04W 28/0278; H04W 28/0252

(57) ABSTRACT

Various aspects of the present disclosure relate to buffer status reporting based on an importance level. A UE may be configured to detect a trigger for buffer status reporting for a set of predefined LCHs. The UE may be configured to generate a BSR for the set of predefined LCHs, where the BSR uses a predefined format. The UE may be configured to transmit the BSR to a RAN.

### TECHNICAL FIELD

The present disclosure relates to wireless communications, and more specifically to Layer-2 (L2) procedures for buffer status reporting for a subset of logical channels (LCHs).

### BACKGROUND

A wireless communications system may include one or multiple network communication devices, such as base stations, which may be otherwise known as an evolved NodeB (eNB), a next-generation NodeB (gNB), or other suitable terminology. Each network communication devices, such as a base station may support wireless communications for one or multiple user communication devices, which may be otherwise known as user equipment (UE), or other suitable terminology. The wireless communications system may support wireless communications with one or multiple user communication devices by utilizing resources of the wireless communication system (e.g., time resources (e.g., symbols, slots, subframes, frames, or the like) or frequency resources (e.g., subcarriers, carriers). Additionally, the wireless communications system may support wireless communications across various radio access technologies including third generation (3G) Radio Access Technology (RAT), fourth generation (4G) RAT, fifth generation (5G) RAT, among other suitable RATs beyond 5G (e.g., sixth generation (6G)).

Current L2 procedures treat all protocol data units (PDUs) of a logical channel (LCH) or radio bearer same in terms of Quality of Service (QoS). If high importance traffic and low importance traffic is mapped to the same LCH or radio bearer, then high importance traffic may not receive appropriate handling. Furthermore, the current buffer status reporting procedure does not distinguish between different types of data within a LCH when reporting the amount of data being available for transmission.

### SUMMARY

An article “a” before an element is unrestricted and understood to refer to “at least one” of those elements or “one or more” of those elements. The terms “a,” “at least one,” “one or more,” and “at least one of one or more” may be interchangeable. As used herein, including in the claims, “or” as used in a list of items (e.g., a list of items prefaced by a phrase such as “at least one of” or “one or more of” or “one or both of”) indicates an inclusive list such that, for example, a list of at least one of A, B, or C means A or B or C or AB or AC or BC or ABC (i.e., A and B and C). Also, as used herein, the phrase “based on” shall not be construed as a reference to a closed set of conditions. For example, an example step that is described as “based on condition A” may be based on both a condition A and a condition B without departing from the scope of the present disclosure. In other words, as used herein, the phrase “based on” shall be construed in the same manner as the phrase “based at least in part on. Further, as used herein, including in the claims, a “set” may include one or more elements.

Some implementations of the method and apparatuses described herein may include a UE comprising a means for detecting a trigger for buffer status reporting for a set of predefined LCHs. The UE described herein may further comprise a means for generating a buffer status report (BSR) for the set of predefined LCHs, where the BSR uses a predefined format. The UE described herein may further comprise a means for transmitting the BSR to a RAN.

### BRIEF DESCRIPTION OF THE DRAWINGS

FIG. 1 illustrates an example of a wireless communication system in accordance with aspects of the present disclosure.

FIG. 2 illustrates an example of a Third Generation Partnership Project (3GPP) New Radio (NR) protocol stack showing different protocol layers in the UE and network, in accordance with aspects of the present disclosure.

FIG. 3 illustrates an example of a procedure for lower layer handling using an importance level, in accordance with aspects of the present disclosure.

FIG. 4 illustrates an example of an architecture for mapping a Packet Data Convergence Protocol (PDCP) entity to multiple radio link control (RLC) entities, in accordance with aspects of the present disclosure.

FIG. 5 illustrates an example of an architecture for mapping a PDCP entity to a common RLC entity that supports multiple LCH priorities, in accordance with aspects of the present disclosure.

FIG. 6 illustrates an example of an architecture for mapping an importance level to a configured grant (CG) configuration, in accordance with aspects of the present disclosure.

FIG. 7 illustrates another example of an architecture for mapping an importance level to a CG configuration, in accordance with aspects of the present disclosure.

FIG. 8 illustrates an example of data prioritization for extended Reality (XR) traffic, in accordance with aspects of the present disclosure.

FIG. 9 illustrates an example of a user equipment (UE) 900, in accordance with aspects of the present disclosure.

FIG. 10 illustrates an example of a processor 1000, in accordance with aspects of the present disclosure.

FIG. 11 illustrates an example of a network equipment (NE) 1100, in accordance with aspects of the present disclosure.

FIG. 12 illustrates a flowchart of a first method performed by a UE for data differentiation for a radio bearer based on an importance level, in accordance with aspects of the present disclosure.

FIG. 13 illustrates a flowchart of a second method performed by a UE for data differentiation for a radio bearer based on an importance level, in accordance with aspects of the present disclosure.

FIG. 14 illustrates a flowchart of a third method performed by a UE for discarding data for transmission based on an importance level, in accordance with aspects of the present disclosure.

FIG. 15 illustrates a flowchart of a fourth method performed by a UE for deprioritizing data for transmission based on an importance level, in accordance with aspects of the present disclosure.

FIG. 16 illustrates a flowchart of a fifth method performed by a UE for buffer status reporting for a subset of logical channels, in accordance with aspects of the present disclosure.

### DETAILED DESCRIPTION

Generally, the present disclosure describes systems, methods, and apparatuses for buffer status reporting for a subset of logical channels. In certain embodiments, the methods may be performed using computer-executable code embedded on a computer-readable medium. In certain embodiments, an apparatus or system may include a computer-readable medium containing computer-readable code which, when executed by a processor, causes the apparatus or system to perform at least a portion of the below described solutions.

Uplink (UL) XR traffic may occur almost periodically (with small jitter) with varying video frame size from one frame to another. Once the radio access network (RAN) knows a video frame has arrived in the buffer of a UE, it could perform dynamic scheduling to assign proper number of resources to the UE for transmitting the video frame. Typically, such dynamic scheduling may incur scheduling delay e.g., due to Scheduling Request (SR) and Buffer Status Report (BSR) transmission delays, particularly, in heavy Downlink (DL) Time Division Duplex (TDD) setup (i.e., DL slots/symbols in between UL slots/symbols). Such a delay may not be desirable due to PDU-Set delay bound (PSDB) requirements for XR video frames.

A QoS flow/radio bearer for XR traffic may carry PDU-Sets with a different importance level, e.g., I-frames and P-frames of a video stream. According to the legacy QoS architecture all data packets of a radio bearer are experiencing the same QoS treatment. This could lead to a situation where for cases that the uplink of the air interface is congested, the UE still tries to transmit low importance data even though the application may not be able to make use of such low importance data, e.g., user experience is not benefitting from some “outdated” low importance data. In order to allow for some distinguished handling of PDU-Sets associated with a high importance level in certain scenarios, prioritization of high importance data and discarding of low importance data in case of congestion, new L2 procedures/mechanism are necessary.

The present disclosure describes several solutions described in various embodiments allowing a differentiation of PDUs/PDU-Sets of a radio bearer associated with a different importance level in various L2 procedures. Disclosed herein is an enhanced BSR procedure which ensures that the arrival of high importance PDUs of a radio bearer is notified to the scheduler in a timely manner by defining a new definition of the data/LCH priority for BSR triggering. Furthermore, a discard procedure is disclosed herein where a RAN entity controls the discarding of low importance data in the event of congestion on the air interface, i.e., low importance data is discarded in order to free-up resources for the transmission of high priority data.

Aspects of the present disclosure are described in the context of a wireless communications system.

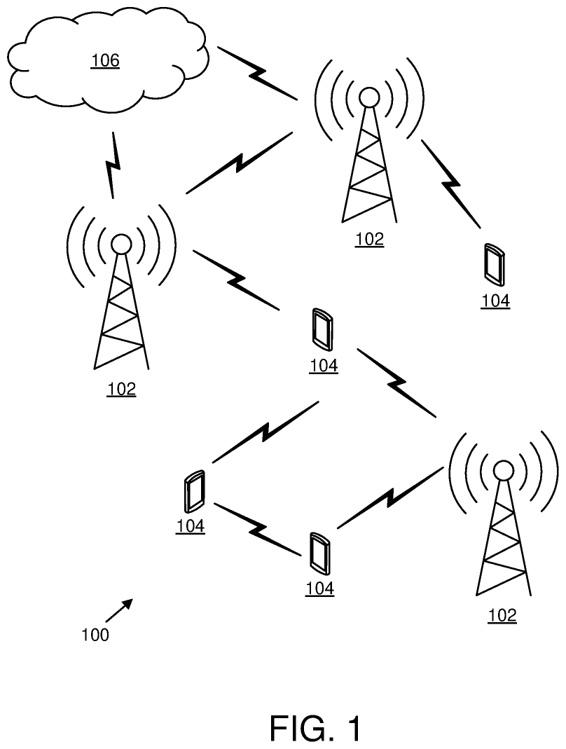

FIG. 1 illustrates an example of a wireless communications system 100 in accordance with aspects of the present disclosure. The wireless communications system 100 may include one or more NE 102, one or more UE 104, and a core network (CN) 106. The wireless communications system 100 may support various radio access technologies. In some implementations, the wireless communications system 100 may be a 4G network, such as a long-term evolution (LTE) network or an LTE-Advanced (LTE-A) network. In some other implementations, the wireless communications system 100 may be a NR network, such as a 5G network, a 5G-Advanced (5G-A) network, or a 5G ultrawideband (5G-UWB) network. In other implementations, the wireless communications system 100 may be a combination of a 4G network and a 5G network, or other suitable radio access technology including Institute of Electrical and Electronics Engineers (IEEE) 802.11 (Wi-Fi), IEEE 802.16 (WiMAX), IEEE 802.20. The wireless communications system 100 may support radio access technologies beyond 5G, for example, 6G. Additionally, the wireless communications system 100 may support technologies, such as time division multiple access (TDMA), frequency division multiple access (FDMA), or code division multiple access (CDMA), etc.

The one or more NE 102 may be dispersed throughout a geographic region to form the wireless communications system 100. One or more of the NE 102 described herein may be or include or may be referred to as a network node, a base station, a network element, a network function, a network entity, a radio access network (RAN), a NodeB, an eNodeB (eNB), a next-generation NodeB (gNB), or other suitable terminology. An NE 102 and a UE 104 may communicate via a communication link, which may be a wireless or wired connection. For example, an NE 102 and a UE 104 may perform wireless communication (e.g., receive signaling, transmit signaling) over a Uu interface.

An NE 102 may provide a geographic coverage area for which the NE 102 may support services for one or more UEs 104 within the geographic coverage area. For example, an NE 102 and a UE 104 may support wireless communication of signals related to services (e.g., voice, video, packet data, messaging, broadcast, etc.) according to one or multiple radio access technologies. In some implementations, an NE 102 may be moveable, for example, a satellite associated with a non-terrestrial network (NTN). In some implementations, different geographic coverage areas associated with the same or different radio access technologies may overlap, but the different geographic coverage areas may be associated with different NE 102.

The one or more UE 104 may be dispersed throughout a geographic region of the wireless communications system 100. A UE 104 may include or may be referred to as a remote unit, a mobile device, a wireless device, a remote device, a subscriber device, a transmitter device, a receiver device, or some other suitable terminology. In some implementations, the UE 104 may be referred to as a unit, a station, a terminal, or a client, among other examples. Additionally, or alternatively, the UE 104 may be referred to as an Internet-of-Things (IoT) device, an Internet-of-Everything (IoE) device, or machine-type communication (MTC) device, among other examples.

A UE 104 may be able to support wireless communication directly with other UEs 104 over a communication link. For example, a UE 104 may support wireless communication directly with another UE 104 over a device-to-device (D2D) communication link. In some implementations, such as vehicle-to-vehicle (V2V) deployments, vehicle-to-everything (V2X) deployments, or cellular-V2X deployments, the communication link may be referred to as a sidelink. For example, a UE 104 may support wireless communication directly with another UE 104 over a PC5 interface.

An NE 102 may support communications with the CN 106, or with another NE 102, or both. For example, an NE 102 may interface with other NE 102 or the CN 106 through one or more backhaul links (e.g., S1, N2, N2, or network interface). In some implementations, the NE 102 may communicate with each other directly. In some other implementations, the NE 102 may communicate with each other or indirectly (e.g., via the CN 106. In some implementations, one or more NE 102 may include subcomponents, such as an access network entity, which may be an example of an access node controller (ANC). An ANC may communicate with the one or more UEs 104 through one or more other access network transmission entities, which may be referred to as a radio heads, smart radio heads, or transmission-reception points (TRPs).

The CN 106 may support user authentication, access authorization, tracking, connectivity, and other access, routing, or mobility functions. The CN 106 may be an evolved packet core (EPC), or a 5G core (5GC), which may include a control plane entity that manages access and mobility (e.g., a mobility management entity (MME), an access and mobility management functions (AMF)) and a user plane entity that routes packets or interconnects to external networks (e.g., a serving gateway (S-GW), a Packet Data Network (PDN) gateway (P-GW), or a user plane function (UPF)). In some implementations, the control plane entity may manage non-access stratum (NAS) functions, such as mobility, authentication, and bearer management (e.g., data bearers, signal bearers, etc.) for the one or more UEs 104 served by the one or more NE 102 associated with the CN 106.

The CN 106 may communicate with a packet data network over one or more backhaul links (e.g., via an S1, N2, N2, or another network interface). The packet data network may include an application server. In some implementations, one or more UEs 104 may communicate with the application server. A UE 104 may establish a session (e.g., a protocol data unit (PDU) session, or the like) with the CN 106 via an NE 102. The CN 106 may route traffic (e.g., control information, data, and the like) between the UE 104 and the application server using the established session (e.g., the established PDU session). The PDU session may be an example of a logical connection between the UE 104 and the CN 106 (e.g., one or more network functions of the CN 106).

In the wireless communications system 100, the NEs 102 and the UEs 104 may use resources of the wireless communications system 100 (e.g., time resources (e.g., symbols, slots, subframes, frames, or the like) or frequency resources (e.g., subcarriers, carriers)) to perform various operations (e.g., wireless communications). In some implementations, the NEs 102 and the UEs 104 may support different resource structures. For example, the NEs 102 and the UEs 104 may support different frame structures. In some implementations, such as in 4G, the NEs 102 and the UEs 104 may support a single frame structure. In some other implementations, such as in 5G and among other suitable radio access technologies, the NEs 102 and the UEs 104 may support various frame structures (i.e., multiple frame structures). The NEs 102 and the UEs 104 may support various frame structures based on one or more numerologies.

One or more numerologies may be supported in the wireless communications system 100, and a numerology may include a subcarrier spacing and a cyclic prefix. A first numerology (e.g., μ=0) may be associated with a first subcarrier spacing (e.g., 15 kHz) and a normal cyclic prefix. In some implementations, the first numerology (e.g., μ=0) associated with the first subcarrier spacing (e.g., 15 kHz) may utilize one slot per subframe. A second numerology (e.g., μ=1) may be associated with a second subcarrier spacing (e.g., 30 kHz) and a normal cyclic prefix. A third numerology (e.g., μ=2) may be associated with a third subcarrier spacing (e.g., 60 kHz) and a normal cyclic prefix or an extended cyclic prefix. A fourth numerology (e.g., μ=3) may be associated with a fourth subcarrier spacing (e.g., 120 kHz) and a normal cyclic prefix. A fifth numerology (e.g., μ=4) may be associated with a fifth subcarrier spacing (e.g., 240 kHz) and a normal cyclic prefix.

A time interval of a resource (e.g., a communication resource) may be organized according to frames (also referred to as radio frames). Each frame may have a duration, for example, a 10 millisecond (ms) duration. In some implementations, each frame may include multiple subframes. For example, each frame may include 10 subframes, and each subframe may have a duration, for example, a 1 ms duration. In some implementations, each frame may have the same duration. In some implementations, each subframe of a frame may have the same duration. Additionally, or alternatively, a time interval of a resource (e.g., a communication resource) may be organized according to slots. For example, a subframe may include a number (e.g., quantity) of slots. The number of slots in each subframe may also depend on the one or more numerologies supported in the wireless communications system 100. For instance, the first, second, third, fourth, and fifth numerologies (i.e., μ=0, μ=1, μ=2, μ=3, μ=4) associated with respective subcarrier spacings of 15 kHz, 30 kHz, 60 kHz, 120 kHz, and 240 kHz may utilize a single slot per subframe, two slots per subframe, four slots per subframe, eight slots per subframe, and 16 slots per subframe, respectively. Each slot may include a number (e.g., quantity) of symbols (e.g., orthogonal frequency division multiplexing (OFDM) symbols). In some implementations, the number (e.g., quantity) of slots for a subframe may depend on a numerology. For a normal cyclic prefix, a slot may include 14 symbols. For an extended cyclic prefix (e.g., applicable for 60 kHz subcarrier spacing), a slot may include 12 symbols. The relationship between the number of symbols per slot, the number of slots per subframe, and the number of slots per frame for a normal cyclic prefix and an extended cyclic prefix may depend on a numerology. It should be understood that reference to a first numerology (e.g., μ=0) associated with a first subcarrier spacing (e.g., 15 kHz) may be used interchangeably between subframes and slots.

In the wireless communications system 100, an electromagnetic (EM) spectrum may be split, based on frequency or wavelength, into various classes, frequency bands, frequency channels, etc. By way of example, the wireless communications system 100 may support one or multiple operating frequency bands, such as frequency range designations FR1 (410 MHz-7.125 GHz), FR2 (24.25 GHz-52.6 GHz), FR3 (7.125 GHz-24.25 GHz), FR4 (52.6 GHz-114.25 GHz), FR4a or FR4-1 (52.6 GHz-71 GHz), and FR5 (114.25 GHz-300 GHz). In some implementations, the NEs 102 and the UEs 104 may perform wireless communications over one or more of the operating frequency bands. In some implementations, FR1 may be used by the NEs 102 and the UEs 104, among other equipment or devices for cellular communications traffic (e.g., control information, data). In some implementations, FR2 may be used by the NEs 102 and the UEs 104, among other equipment or devices for short-range, high data rate capabilities.

FR1 may be associated with one or multiple numerologies (e.g., at least three numerologies). For example, FR1 may be associated with a first numerology (e.g., μ=0), which includes 15 kHz subcarrier spacing; a second numerology (e.g., μ=1), which includes 30 kHz subcarrier spacing; and a third numerology (e.g., μ=2), which includes 60 kHz subcarrier spacing. FR2 may be associated with one or multiple numerologies (e.g., at least 2 numerologies). For example, FR2 may be associated with a third numerology (e.g., μ=2), which includes 60 kHz subcarrier spacing; and a fourth numerology (e.g., μ=3), which includes 120 kHz subcarrier spacing.

For initial access, a UE 104 detects a candidate cell and performs downlink (DL) synchronization. For example, the gNB (e.g., an embodiment of the NE 102) may transmit a synchronization signal and broadcast channel (SS/PBCH) transmission, referred to as a Synchronization Signal Block (SSB). The synchronization signal is a predefined data sequence known to the UE 104 (or derivable using information already stored at the UE 104) and is in a predefined location in time relative to frame/subframe boundaries, etc. The UE 104 searches for the SSB and uses the SSB to obtain DL timing information (e.g., symbol timing) for the DL synchronization. The UE 104 may also decode system information (SI) based on the SSB.

Note that with beam-based communication, each DL beam may be associated with a respective SSB. In 3GPP New Radio (NR), the gNB may transmit the maximum 64 SSBs and the maximum 64 corresponding copies of Physical Downlink Control Channel (PDCCH) and/or Physical Downlink Shared Channel (PDSCH) for delivery of System Information Block #1 (SIB1) in high frequency bands (e.g., 28 GHz).

In the following, instead of “slot,” the terms “mini-slot,” “subslot,” or “aggregated slots” can also be used, wherein the notion of slot/mini-slot/sub-slot/aggregated slots can be described as defined in 3GPP Technical Specification (TS) 38.211, TS 38.213, and/or TS 38.214. Throughout this disclosure reference to TS 38.211, TS 38.212, TS 38.213, TS 38.214 is associated with version 16.4.0 of the 3GPP specifications.

Several solutions to provide variable resource timing and size are described below. According to a possible embodiment, one or more elements or features from one or more of the described solutions may be combined.

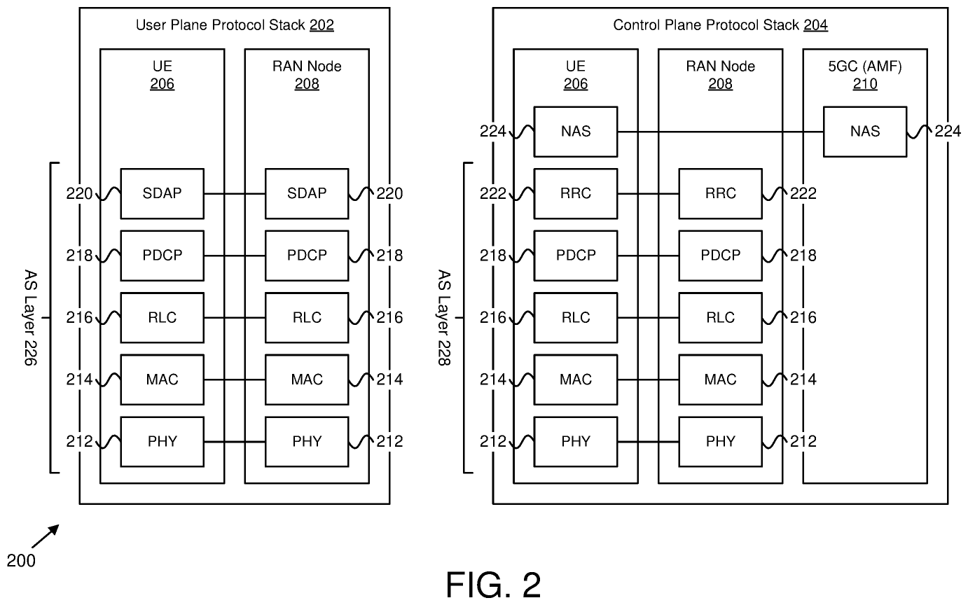

FIG. 2 illustrates an example of a NR protocol stack 200, in accordance with aspects of the present disclosure. While FIG. 2 shows a UE 206, a RAN node 208, and a 5G core network (5GC) 210 (e.g., comprising at least an AMF), these are representative of a set of UEs 104 interacting with an NE 102 (e.g., base station) and a CN 106. As depicted, the NR protocol stack 200 comprises a User Plane protocol stack 202 and a Control Plane protocol stack 204. The User Plane protocol stack 202 includes a physical (PHY) layer 212, a MAC sublayer 214, a Radio Link Control (RLC) sublayer 216, a Packet Data Convergence Protocol (PDCP) sublayer 218, and a Service Data Adaptation Protocol (SDAP) layer 220. The Control Plane protocol stack 204 includes a PHY layer 212, a MAC sublayer 214, a RLC sublayer 216, and a PDCP sublayer 218. The Control Plane protocol stack 204 also includes a Radio Resource Control (RRC) layer 222 and a Non-Access Stratum (NAS) layer 224.

The AS layer 226 (also referred to as “AS protocol stack”) for the User Plane protocol stack 202 consists of at least SDAP, PDCP, RLC and MAC sublayers, and the physical layer. The AS layer 228 for the Control Plane protocol stack 204 consists of at least RRC, PDCP, RLC and MAC sublayers, and the physical layer. The Layer-1 (L1) includes the PHY layer 212. The Layer-2 (L2) is split into the SDAP sublayer 220, PDCP sublayer 218, RLC sublayer 216, and MAC sublayer 214. The Layer-3 (L3) includes the RRC layer 222 and the NAS layer 224 for the control plane and includes, e.g., an internet protocol (IP) layer and/or PDU Layer (not depicted) for the user plane. L1 and L2 are referred to as “lower layers,” while L3 and above (e.g., transport layer, application layer) are referred to as “higher layers” or “upper layers.”

The PHY layer 212 offers transport channels to the MAC sublayer 214. The PHY layer 212 may perform a beam failure detection procedure using energy detection thresholds, as described herein. In certain embodiments, the PHY layer 212 may send an indication of beam failure to a MAC entity at the MAC sublayer 214. The MAC sublayer 214 offers logical channels to the RLC sublayer 216. The RLC sublayer 216 offers RLC channels to the PDCP sublayer 218. The PDCP sublayer 218 offers radio bearers to the SDAP sublayer 220 and/or RRC layer 222. The SDAP sublayer 220 offers QoS flows to the core network (e.g., 5GC). The RRC layer 222 provides for the addition, modification, and release of Carrier Aggregation and/or Dual Connectivity. The RRC layer 222 also manages the establishment, configuration, maintenance, and release of Signaling Radio Bearers (SRBs) and Data Radio Bearers (DRBs).

The NAS layer 224 is between the UE 206 and an AMF in the 5GC 210. NAS messages are passed transparently through the RAN. The NAS layer 224 is used to manage the establishment of communication sessions and for maintaining continuous communications with the UE 206 as it moves between different cells of the RAN. In contrast, the AS layers 226 and 228 are between the UE 206 and the RAN (i.e., RAN node 208) and carry information over the wireless portion of the network. While not depicted in FIG. 2, the IP layer exists above the NAS layer 224, a transport layer exists above the IP layer, and an application layer exists above the transport layer.

The MAC sublayer 214 is the lowest sublayer in the L2 architecture of the NR protocol stack. Its connection to the PHY layer 212 below is through transport channels, and the connection to the RLC sublayer 216 above is through logical channels. The MAC sublayer 214 therefore performs multiplexing and demultiplexing between logical channels and transport channels: the MAC sublayer 214 in the transmitting side constructs MAC PDUs (also known as Transport Blocks (TBs)) from MAC Service Data Units (SDUs) received through logical channels, and the MAC sublayer 214 in the receiving side recovers MAC SDUs from MAC PDUs received through transport channels.

The MAC sublayer 214 provides a data transfer service for the RLC sublayer 216 through logical channels, which are either control logical channels which carry control data (e.g., RRC signaling) or traffic logical channels which carry user plane data. On the other hand, the data from the MAC sublayer 214 is exchanged with the PHY layer 212 through transport channels, which are classified as UL or DL. Data is multiplexed into transport channels depending on how it is transmitted over the air.

The PHY layer 212 is responsible for the actual transmission of data and control information via the air interface, i.e., the PHY layer 212 carries all information from the MAC transport channels over the air interface on the transmission side. Some of the important functions performed by the PHY layer 212 include coding and modulation, link adaptation (e.g., Adaptive Modulation and Coding (AMC)), power control, cell search and random access (for initial synchronization and handover purposes) and other measurements (inside the 3GPP system (i.e., NR and/or LTE system) and between systems) for the RRC layer 222. The PHY layer 212 performs transmissions based on transmission parameters, such as the modulation scheme, the coding rate (i.e., the modulation and coding scheme (MCS)), the number of Physical Resource Blocks (PRBs), etc.

Note that an LTE protocol stack comprises similar structure to the NR protocol stack 200, with the differences that the LTE protocol stack lacks the SDAP sublayer 220 in the AS layer 226, that an EPC replaces the 5GC 210, and that the NAS layer 224 is between the UE 206 and an MME in the EPC. Also note that the present disclosure distinguishes between a protocol layer (such as the aforementioned PHY layer 212, MAC sublayer 214, RLC sublayer 216, PDCP sublayer 218, SDAP sublayer 220, RRC layer 222 and NAS layer 224) and a transmission layer in Multiple-Input Multiple-Output (MIMO) communication (also referred to as a “MIMO layer” or a “data stream”).

A service-oriented design considering XR traffic characteristics (e.g., (a) bursty quasi-periodic packets coming at 30-120 frames/second with some jitter, (b) packets having variable and large packet size, (c) B/P-frames being dependent on I-frames, (d) presence of multiple traffic/data flows such as pose (i.e., user orientation/position) and video scene in uplink, (e) various degrees of importance between I/P/B-frames in contributing to the end-to-end quality of user experience) can enable more efficient (e.g., in terms of satisfying XR service requirements for a greater number of UEs, in terms of UE power saving, or in terms of XR traffic reliability and rendering robustness against wireless networks transmissions effects) XR service delivery.

XR is an umbrella term for different types of realities including: Virtual Reality (VR), Augmented Reality (AR), and Mixed Reality (MR).

Virtual reality (VR) is a rendered version of a delivered visual and audio scene. The rendering is designed to mimic the visual and audio sensory stimuli of the real world as naturally as possible to an observer or user as they move within the limits defined by the application. Virtual reality usually, but not necessarily, requires a user to wear a head mounted display (HMD), to completely replace the user's field of view with a simulated visual component, and to wear headphones, to provide the user with the accompanying audio. Some form of head and motion tracking of the user in VR is usually also necessary to allow the simulated visual and audio components to be updated to ensure that, from the user's perspective, items and sound sources remain consistent with the user's movements. Additional means to interact with the virtual reality simulation may be provided but are not strictly necessary. Augmented reality (AR) is when a user is provided with additional information or artificially generated items, or content overlaid upon their current environment. Such additional information or content will usually be visual and/or audible, and their observation of their current environment may be direct, with no intermediate sensing, processing, and rendering, or indirect, where their perception of their environment is relayed via sensors and may be enhanced or processed.

Mixed reality (MR) is an advanced form of AR where some virtual elements are inserted into the physical scene with the intent to provide the illusion that these elements are part of the real scene.

XR refers to all real-and-virtual combined environments and human-machine interactions generated by computer technology and wearables. It includes representative forms such as AR, MR and VR and the areas interpolated among them. The levels of virtuality range from partially sensory inputs to fully immersive VR. A key aspect of XR is the extension of human experiences especially relating to the senses of existence (represented by VR) and the acquisition of cognition (represented by AR).

Many of the XR and CG use cases are characterized by quasi-periodic traffic (with possible jitter) with high data rate in DL (i.e., video steam) combined with the frequent UL (i.e., pose/control update) and/or UL video stream. Both DL and UL traffic are also characterized by relatively strict Packet Delay Budget (PDB).

The set of anticipated XR and CG services has a certain variety and characteristics of the data streams (i.e., video) may change “on-the-fly,” while the services are running over NR. Therefore, additional information on the running services from higher layers, e.g., the QoS flow association, frame-level QoS, ADU-based QoS, XR-specific QoS, etc., may be beneficial to facilitate informed choices of radio parameters. It is clear that XR application awareness by UE and gNB would improve the user experience, improve the NR system capacity in supporting XR services, and reduce the UE power consumption.

An Application Data Unit (ADU) (also referred to as PDU set) is the smallest unit of data that can be processed independently by an application (such as processing for handling out-of-order traffic data). A video frame can be an I-frame, P-frame, or can be composed of I-slices, and/or P-slices. I-frames/I-slices are more important and larger than P-frames/P-slices or B-frames/B-slices. An ADU can be one or more I-slices, P-slices, I-frame, P-frame, or a combination of those. As known in the art, there are three major picture types used in the different video algorithms, referred to as I-frames, P-frames, and B-frames. These types are different in the following characteristics: I-frames are the least compressible but do not require other video frames to decode (i.e., each is an independent frame). P-frames can use data from previous frames to decompress and are more compressible than I-frames (i.e., each is a dependent frame requiring data from another frame). B-frames can use both previous and forward frames for data reference to get the highest amount of data compression (i.e., each is a dependent frame requiring data from another frame).

The latency requirement of XR traffic in RAN side (i.e., air interface) is modelled as PDB. The PDB is a limited time budget for a packet to be transmitted over the air from a gNB to a UE. The value of PDB may vary for different applications and traffic types, which can be 10-20 ms depending on the application (see 3GPP Technical Report (TR) 26.926).

For a given packet, the delay of the packet incurred in air interface is measured from the time that the packet arrives at the gNB to the time that it is successfully transferred to the UE. If the delay is larger than a given PDB for the packet, then, the packet is said to violate PDB, otherwise the packet is said to be successfully delivered.

5G arrival time of data bursts on the downlink can be quasi periodic i.e. periodic with jitter. Some of the factors leading to jitter in burst arrival include varying server render time, encoder time, Real-time Transport Protocol (RTP) packetization time, link between server and 5G gateway etc. 3GPP agreed simulation assumptions for XR evaluation model DL traffic arrival jitter using truncated Gaussian distribution with mean: Oms, std. dev: 2 ms, range: [−4 ms, 4 ms] (baseline), [−5 ms, 5 ms] (optional).

Applications can have a certain delay requirement on a PDU-Set/ADU, that may not be adequately translated into packet delay budget requirements. For example, if the PDU-Set Delay Budget (PSDB) is 10 ms, then PDB can be set to 10 ms only if all packets of the PDU-Set arrive at the 5G system at the same time. If the packets are spread out, then PDU-Set delay budget is measured either in terms of the arrival of the first packet of the PDU-Set or the last packet of the PDU-Set. In either case, a given PDU-Set will result in different PDB requirements on different packets of the PDU-Set. It is observed that specifying the PDU-Set to the 5G system can be beneficial.

With regard to delay-aware communication, if the scheduler, and/or the UE is aware of delay budgets for a packet/ADU, the gNB can take this knowledge into account in scheduling transmissions, e.g., by giving priority to transmissions close to their delay budget limit, and by not scheduling (e.g., UL) transmissions; the UE can also take advantage of such knowledge to determine 1) if an UL transmission (e.g., a physical uplink control channel (PUCCH) transmission made in response to a PDSCH, UL pose, or physical uplink shared channel (PUSCH) transmission) corresponding to a transmission that exceeds its delay budget can be dropped (additionally, no need to wait for re-transmission of a PDSCH and no need to keep the erroneously received PDSCH in buffer for soft combining with a re-transmission that never occurs) or 2) how much of its channel occupancy time in case of using unlicensed spectrum can be shared with the gNB.

The remaining delay budget 1) for a DL transmission can be indicated to the UE in a Downlink Control Information (DCI) (e.g., for a packet of a ADU/video frame/slice/PDU-Set) or via a MAC Control Element (CE) (e.g., for an ADU/video frame/slice/PDU-Set) and 2) for an UL transmission can be indicated to the gNB via an UL transmission such as uplink control information (UCI), PUSCH transmission, etc.

3GPP discusses PDU-Set related QoS aspects of XR that can be conveyed to the RAN to optimize the communication such as PDU-Set Error Rate (PSER) and/or PDU-Set Delay Budget (PSDB).

In both uplink and downlink, XR-Awareness contributes to optimizations of gNB radio resource scheduling and relies at least on the notions of PDU-Set and Data Burst (see e.g., 3GPP TR 23.700-60): a PDU-Set (also denoted “PDU Set”) is composed of one or more PDUs carrying the payload of one unit of information generated at the application level (e.g. a frame or video slice), while a Data Burst is a set of data PDUs generated and sent by the application in a short period of time. Note that a Data Burst can be composed of multiple PDUs belonging to one or multiple PDU-Sets.

The following information may be provided by the core network (CN) to the RAN to assist the handling of QoS flows and PDUs: A) Semi-static information for both UL and DL provided via control plane (NGAP); B) Periodicity for UL and DL traffic of the QoS Flow via TSCAI/TSCAC; C) Traffic jitter information (e.g., jitter range) associated with each periodicity of the QoS flow; D) PDU-Set QoS parameters (i.e., including one or more of: 1) PDU-Set Error Rate (PSER); 2) PDU-Set Delay Budget (PSDB); and/or 3) PDU-Set Integrated Indication (PSII), i.e., whether all PDUs are needed for the usage of PDU-Set by application layer); and/or E) Dynamic information for DL provided by user plane, e.g., GTP-U header (i.e., including one or more of: 1) PDU-Set Sequence Number; 2) PDU-Set Size in bytes; 3) PDU Sequence Number (SN) within a PDU-Set; 4) End PDU of the PDU-Set; 5) PDU-Set Importance; and/or 6) End of Data Burst indication in the header of the last PDU of the Data Burst (optional)).

The PSER defines an upper bound for the rate of PDU-Sets that have been processed by the sender of a link layer protocol but that are not successfully delivered by the corresponding receiver to the upper layer (see 3GPP TR 23.700-60). As used herein, a PDU-Set is considered as successfully delivered when all PDUs of a PDU-Set are delivered successfully.

The PSDB defines the time between reception of the first PDU and the successful delivery of the last arrived PDU of a PDU-Set (see 3GPP TR 23.700-60). PSDB is an optional parameter. The PDU-Set Importance parameter is used to identify the importance of a PDU-Set within a QoS flow. The RAN may use this parameter for PDU-Set level packet discarding in presence of congestion.

With regard to the jitter aspects of XR traffic, the packet arrival rate is determined by the XR application frame generation rate, e.g., 30/60/90/120 frames-per-second (fps). Accordingly, the average packet arrival periodicity is given by the inverse of the frame rate, e.g., 16.6667 ms=1/60 fps. Thus, the periodic arrival time without jitter at the gNB of XR packets indexed by k=1,2,3, . . . is

$${τ}_{k} = \frac{k}{F} \cdot 1000 [ ms ] , \qquad Equation 1$$

where F denotes the XR application video frame generation rate (per second).

This periodic packet arrival model implicitly assumes fixed delay contributed from network side including fixed video encoding time, fixed network transfer delay, etc.

However, in a real system, the varying frame encoding delay and network transfer time introduces stochastic jitter in packet arrival time at the gNB. Generically, the jitter is modelled as a truncated Gaussian random process resulting into a random variable added on top of periodic arrivals. The jitter contribution to the packet arrival time thus generates an additive truncated Gaussian distribution to the inherent ideal periodicity of the XR DL traffic with statistical parameters according to 3GPP TR 38.838 (v1.0.1) displayed in Table 1, below.

TABLE 1
Statistical parameters for jitter of DL XR traffic

| | | Baseline | Optional |
|---|---|---|---|
| | Unit of | model value | model value |
| Parameter | measure | for evaluation | for evaluation |
| Mean | ms | 0 | |
| Standard deviation | ms | 2 | |
| Truncation range | ms | [−4, 4] | [−5, 5] |

Note that the given parameter values and considered frame generation rates (60 or 120 in this model) ensure that packet arrivals are in order (i.e., arrival time of a next packet is always larger than that of the previous packet). Given the jitter model considered in 3GPP for Fifth Generation (5G) and beyond radio access networks (RANs), even for high frame generation rates, e.g., 120 fps, the given parameter values and considered frame generation rates ensures in-order packet arrivals (i.e., arrival time of a next packet is always larger than that of the previous packet). Concretely, the XR traffic model of periodic arrival with jitter for an arrival time of a video frame packet with index k=1,2,3, . . . is summarized by

$${τ}_{k} = offset + \frac{k}{F} \cdot 1000 + J [ ms ] , \qquad Equation 2$$

where F is the given frame generation rates (per second) and/is the jitter specific random variable following the model of Table 1. Moreover, the actual traffic arrival timing of traffic for each UE could be shifted by the UE-specific, arbitrary value offset.

With regard to BSR, once a BSR is triggered, BSR information is multiplexed in a PUSCH. BSR information indicates how much data associated to one or more Logical Channel Groups (LCGs) is available in the UE's buffer for transmission. There could be several BSR triggering conditions as described in greater detail in the appendix.

Regarding the dynamic adaptation of Discontinuous Reception (DRX) Parameters or a DRX Configuration, DCI (e.g., within DRX active time) can indicate to update one or more of C-DRX cycle, OnDurationTimer, or InactivityTimer (e.g., for the current or upcoming DRX cycle). For instance, a communication entity may consider DCI signaling within the active time of a DRX cycle to indicate such an update.

Regarding multiple simultaneous DRX configurations, the network can enable multiple simultaneous DRX configurations to a UE, wherein different DRX configurations are almost aligned with arrival of different traffic flows. For instance, each DRX configuration can be configured with the traffic periodicity and the DRX cycle start can be aligned with the expected application packet arrival (or start of the jitter range) of one specific traffic flow.

Regardless of the DRX parameter values selected for each configuration, the multi-flow DRX solution works as follows:

The UE monitors the PDCCH while the drx-onDurationTimer (or drx-InactivityTimer) is running in any of the DRX configurations, i.e., the overall active time is a logical ‘OR’ of the active times given by each DRX configuration. If a PDCCH is received for a new transmission, then any drx-InactivityTimer that is running at that time could be re-started.”

For future networks, one possible mapping option for XR-communication will be that PDU-Sets of different importance level are mapped to the same QoS flow and radio bearer. One example of such mapping option would be for example that I-frame and P-frames of a video stream are carried by the same QoS flow/radio bearer.

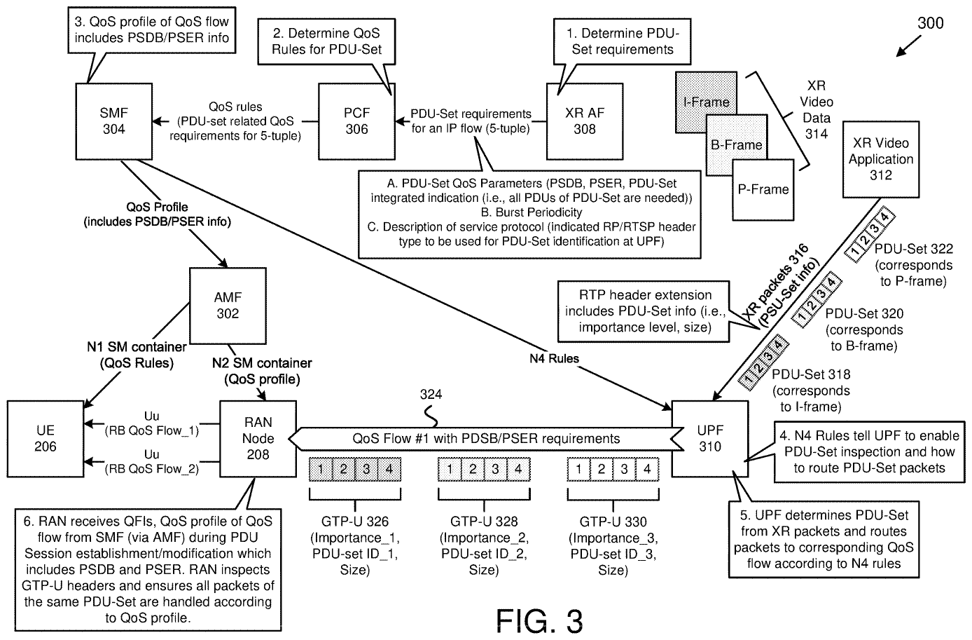

FIG. 3 depicts an exemplary procedure 300 for lower layer handling of XR traffic using an importance level, in accordance with aspects of the present disclosure. A QoS flow/radio bearer for XR traffic may carry PDU-Sets with a different importance level, e.g. I-frames and P-frames of a video stream. The procedure 300 involves the UE 206, the RAN node 208, an AMF 302, a session management function (SMF) 304, a policy control function (PCF) 306, an XR and/or extended reality media (XRM) AF application function (AF) 308, a UPF 310, and an XR video application 312.

At step 1, the XR/XRM AF 308 determines the PDU-Set requirements for an IP flow and transmits the PDU-Set requirements to the PCF 306. The IP flow is uniquely defined by a 5-tuple (e.g., source IP address, source transmission control protocol and/or user datagram protocol (TCP/UDP) port, destination IP address, destination TCP/UDP port and IP protocol). The PDU-Set requirements include A) PDU-Set QoS parameters, B) Burst periodicity, and C) a description of service protocol. The PDU-Set QoS parameters may include one or more of the following: PSDB, PSER, and/or a PDU-Set integrated indication (i.e., an indication that all PDUs of PDU-Set are needed). The service protocol description indicates Real Time Protocol and/or Real Time Streaming Protocol (RTP/RTSP) header type to be used for PDU-Set identification at the UPF 310.

At step 2, based on the PDU-Set requirements, the PCF 306 determines a set of QoS rules for the PDU-Set, and transmits the QoS rules to the SMF 304. The QoS rules may use a 5G QoS identifier (5QI) for XR media traffic. The QoS rules comprise PDU-set related QoS requirements for the 5-tuple. The PCF 306 may include in the communication to the SMF 304 PCC rules per importance of a PDU set. The PCC rules may be derived according to information received from the XR/XRM AF 308, or based on an operator configuration.

At step 3, based on the QoS rules for the PDU-Set, the SMF 304 determines a QoS profile for a QoS flow, and transmits the QoS profile to the AMF 302. The QoS profile comprises, e.g., PSDB and/or PSER information. The SMF 304 establishes a QoS flow according to the QoS rules by the PCF and configures the UPF to route packets of the XR application to a QoS flow, and, in addition, to enable PDU set handling. Note that the AMF 302 transmits a message with an N1 Session Management (SM) container with QoS rules to the UE 206, and also transmits a message with an N2 SM container with the QoS profile containing the PSU set QoS requirements to the RAN node 208.

At step 4, based on the QoS rules for the PDU-Set, the SMF 304 determines a set of N4 rules, and transmits the N4 rules to the UPF 310. The N4 rules instruct the UPF 310 to enable PDU-Set inspection and how to route PDU-Set packets.

At step 5, the UPF 310 identifies the PDU-Set from XR packets and routes packets to corresponding QoS flow according to N4 rules. In the depicted example, an XR packet 316 (i.e., transmitted from the XR video application 312 to the UPF 310) comprises a first PDU-set 318 (i.e., corresponding to an I-frame of XR video data 314), a second PDU-set 320 (i.e., corresponding to a B-frame of XR video data 314), and a third PDU-set 322 (i.e., corresponding to a P-frame of XR video data 314). Note that the XR packet 316 comprises an RTP header extension which includes PDU-Set information, i.e., importance level information and size information.

As depicted, a first QoS flow 324 is established between the UPF 310 and the RAN node 208 with the PSDB and/or PSER requirements. Via the first QoS flow 324, the UPF 310 transmits first GPRS Tunnelling Protocol User Plane (GTP-U) data 326 having a first importance level, a first PDU-set identifier (ID), and a first size. Additionally, the UPF 310 transmits second GPRS Tunnelling Protocol User Plane (GTP-U) data 328 having a second importance level, a second PDU-set ID, and a second size. Further, the UPF 310 transmits third GPRS Tunnelling Protocol User Plane (GTP-U) data 330 having a third importance level, a third PDU-set ID, and a third size.

At step 6, during PDU Session establishment/modification the RAN node 208 receives the QoS Flow Identifiers (QFIs) and the QoS profile of the first QoS flow 324 from the SMF 304 (via the AMF 302) which includes PSDB and PSER. The RAN node 208 inspects the GTP-U headers and ensures all packets of the same PDU-Set are handled according to QoS profile.

According to the legacy QoS architecture all data packets of a radio bearer are experiencing the same QoS treatment. In order to allow for some distinguished handling of PDU-Sets associated with a high importance level in certain scenarios, e.g., prioritization of high importance data and discarding of low importance data in case of congestion, new L2 procedures/mechanism are necessary. Furthermore, the current buffer status reporting procedure does not distinguish between different types of data within a LCH when reporting the amount of data being available for transmission. In order to allow for some distinguished handling of PDU-Sets associated with a high importance level in certain scenarios, the gNB needs be aware of the different types of PDUs, e.g., data of different importance level, pending in the UE's buffer for transmission. Disclosed herein are particular solutions which aim at avoiding or reducing the congestion on the air interface, e.g., for uplink transmissions, by considering the importance level a PDU/PDU-Set is associated with.

According to embodiments of a first solution, the PDCP layer of a UE 206 performs routing of PDCP PDUs to one of a plurality of RLC entities/bearers based on importance information associated with a PDCP Service Data Unit (SDU). The PDCP layer (e.g., an implementation of the PDCP sublayer 218) in the transmitting side constructs PDCP PDUs from PDCP SDUs received through radio bearer/QoS flows from an upper layer (e.g., RRC or SDAP) and routes the PDCP PDU to an RLC entity. Similarly, the PDCP layer in the receiving side recovers PDCP SDUs from PDCP PDUs received through RLC channels from an RLC entity.

According to one embodiment of the first solution, the PDCP layer of a UE 206 performs the routing of PDCP PDUs to the associated RLC entities based on some information attached to a PDCP SDU. According to one implementation of the first solution, the PDCP layer is associated with multiple RLC entities.

According to one implementation of the first solution, the information used for routing is a PDU-Set Importance, e.g., this parameter is used to identify the importance of a PDU-Set within a QoS flow. In one example, the information based on which the routing of PDCP PDUs is done, i.e., PDU-Set importance, is included in the PDCP SDU delivered by higher layer, e.g., an SDAP PDU. In one example, the SDAP PDU includes a new field in a SDAP header which carries the importance information. In one specific implementation, the importance information is included in the SDAP header for each SDAP PDU.

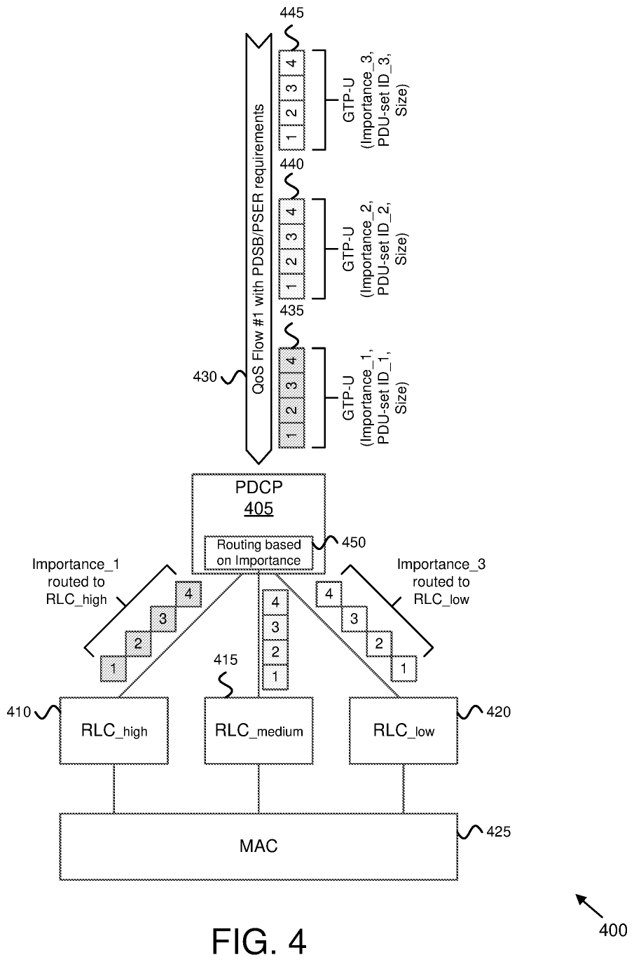

FIG. 4 illustrates an exemplary architecture 400 for lower layer handling of new data using an importance level, in accordance with aspects of the present disclosure. FIG. 4 depicts a PDCP layer 405 (e.g., an implementation of the PDCP sublayer 218) associated with a plurality of RLC entities (e.g., implementations of the RLC sublayer 216), including a first RLC entity 410 for high priority/importance data (denoted “RLC_high”), a second RLC entity 415 for medium priority/importance data (denoted “RLC_medium”), and a third RLC entity 420 for low priority/importance data (denoted “RLC_low”). In turn, the RLC entities 410-420 are associated with a MAC layer entity 425 (e.g., an implementation of the MAC sublayer 214).

Via upper layers, the PDCP layer 405 receives a first QoS flow 430 (denoted “QoS flow #1”) with PSDB and/or PSER requirements. The data associated with the first QoS flow 430 includes a first PDU-Set 435, e.g., GPRS Tunnelling Protocol User Plane (GTP-U) data, having a first importance level (denoted “Importance_1”) and a first PDU-Set ID (denoted “PDU-Set ID_1”). The data associated with the first QoS flow 430 also includes a second PDU-Set 440, e.g., GTP-U data, having a second importance level (denoted “Importance_2”) and a second PDU-Set ID (denoted “PDU-Set ID_2”). The data associated with the first QoS flow 430 further includes a third PDU-Set 445, e.g., GTP-U data, having a third importance level (denoted “Importance_3”) and a third PDU-Set ID (denoted “PDU-Set ID_3”).

The PDCP layer 405 performs routing 450 based on importance. Here it is assumed that Importance_1 is of greater importance than Importance_2, and both are of greater importance than Importance_3 (i.e., Importance_1>Importance_2>Importance_3). Accordingly, the PDCP layer 405 routes the first PDU-Set 435 to the first RLC entity, routes the second PDU-Set 440 to the second RLC entity, and routes the third PDU-Set 445 to the third RLC entity.

In one implementation of the first solution, the importance information is included in the PDCP PDU header. For example, the SDAP layer may provide the importance information with every delivered SDAP PDU, e.g., inter-layer communication. In one example, the PDCP PDU header comprises a new field carrying the importance level of the corresponding PDCP PDU.

In one example of the first solution, the PDCP layer 405 is provided with a mapping configuration, i.e., specifying the mapping between an importance value and a RLC entity or RLC bearer (denoted herein as “RLC entity/bearer”). In one example, the PDCP layer 405 of the UE 206 uses the mapping information for the routing of PDCP PDUs to the associated RLC entities 410-420.

According to one embodiment of the first solution, the RAN node 208 (e.g., gNB) is provided with the number of importance levels supported for a QoS flow/DRB. In one example, the information on number of importance levels used for a QoS flow/DRB is signaled within the XR assistance information provided to the RAN by the core network. In one specific implementation the semi-static information provided via control plane (e.g., using Next Generation Application Protocol (NGAP) signaling) indicates the number of importance levels used for a QoS flow/DRB. The RAN node 208 (e.g., gNB) uses such information to configure the corresponding number of RLC entities/LCHs.

Under current 3GPP specifications, PDCP control PDUs do not have an associated importance level. Hence some special routing method needs to be used. Note that a PDCP PDU can also be of two types depending on the plane: a PDCP control PDU or a PDCP data PDU. As an example, a PDCP control PDU may include a PDCP status report.

According to one embodiment of the first solution, PDCP control PDUs are delivered from the PDCP layer 405 to the RLC entity having the highest priority LCH (e.g., the “RLC-high” entity) for cases that the PDCP entity is associated with multiple RLC entities/LCHs.

In another embodiment of the first solution, PDCP control PDUs can be carried via any of the LCHs/RLC entities associated with the common PDCP entity, i.e., having no specific mapping restriction for PDCP control PDUs. In a further embodiment, the UE 206 may be configured with a specific mapping between PDCP control PDUs and LCH(s).

According to one embodiment of the first solution, a BSR is triggered based on new data becoming available for transmission and this data has a higher priority than the priority of any other data which is available for transmission. According to one implementation of this embodiment, the priority of the data becoming available for transmission, e.g., arriving in the PDCP, is determined based on the importance level associated with the data. In one example, the UE 206 determines the priority of the data based on the mapping between the importance level of the data, e.g., PDCP SDU, and the associated LCH priority. In one example, the priority of the data is the priority of the LCH to which a PDCP SDU is/will be routed based on the importance level of the data.

According to one embodiment, when indicating a PDCP data volume to a MAC entity for BSR triggering and Buffer size calculation, the PDCP layer 405 indicates the PDCP data volume per importance level to the MAC layer entity 425. In one exemplary implementation, the buffer levels indicated in the BSR should indicate the amount of data per importance level, e.g., for each of the LCHs associated with a PDCP entity a separate buffer level is indicated within the BSR.

In another exemplary implementation, the UE splits the data volume of the (common) PDCP entity among the multiple associated RLC entities in order to compute a data volume per RLC bearer, i.e. data volume of the RLC bearer corresponds to the sum of the RLC data volume and the amount of the PDCP data volume which is associated to the corresponding RLC entity-based on the importance value associated with a PDCP SDU/PDU and the mapping between importance value and RLC entity/bearer/LCH.

As an example, in the case where the PDCP entity is associated with two RLC entities—one for high importance data (I-frame) and another LCH for low importance data (P/B-frame)—the PDCP data volume is split in 2 parts, i.e., one corresponding to the high importance PDCP SDUs/PDUs and one accounting for the low importance PDCP SDUs/PDUs.

In order to provide the full information to the gNB for efficient scheduling, the gNB should have information on the amount of data available for transmission for each of the multiple LCHs/RLC entities which are associated with the PDCP entity. For cases when the different LCHs which are associated with the common PDCP entity are mapped to different LCGs, the current buffer status MAC CE format allows to indicate the buffer status per importance level-given that the PDCP data volume is split/shared among the different RLC entities/bearers as described above. In another example—for cases when the LCHs associated with the common PDCP entity are mapped to the same LCG—a new BSR MAC CE format is introduced where the buffer status is indicated per importance level for a respective LCG.

According to embodiments of a second solution, the PDCP layer of a UE 206 performs routing of PDCP PDUs to a common RLC entity that supports multiple LCH priorities.

According to one embodiment of the second solution, a LCH is configured with multiple LCH priorities. Each of the configured priorities is associated with an importance level, e.g., first LCH priority is mapped to the first (for example lowest) importance level, second LCH priority is mapped to the second (next highest) importance level, etc.

In one embodiment of the second solution, an explicit mapping between importance level and LCH priority is configured. In one implementation, the multiple priorities associated with a LCH are configured within the Information Element (IE) logicalchannelconfig. According to one implementation of this embodiment, the mapping between importance level and LCH priorities is configured by RRC signaling. Thereafter, depending on the importance of the data, i.e., importance level associated with the data of a LCH, the UE 206 (e.g., at the MAC sublayer 214) uses the mapped LCH priority for the BSR procedure, e.g., determining whether a BSR is triggered.

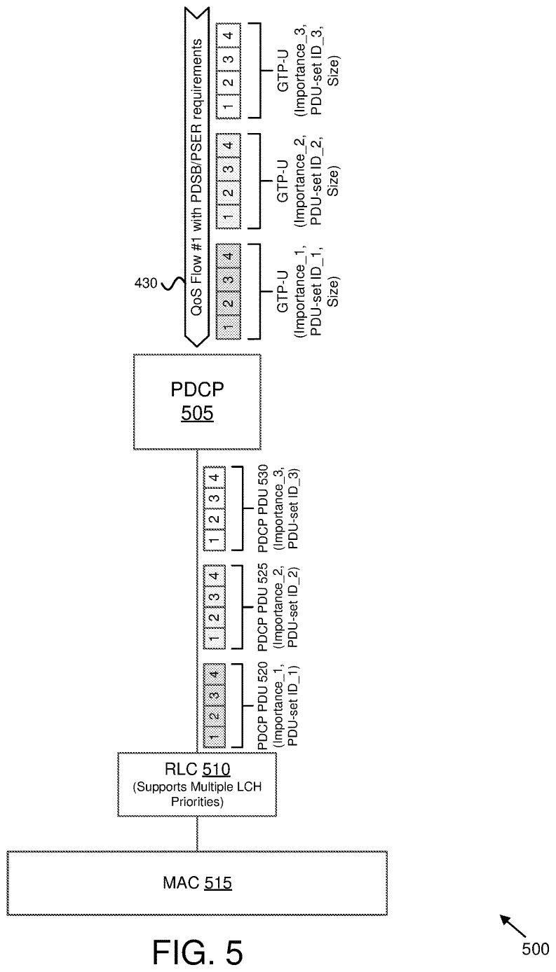

FIG. 5 illustrates an exemplary architecture 500 for lower layer handling of new data using an importance level, in accordance with aspects of the present disclosure. FIG. 5 depicts a PDCP layer/entity 505 (e.g., an implementation of the PDCP sublayer 218) associated with a common RLC entity 510 (e.g., an implementation of the RLC sublayer 216) that supports multiple LCH priorities. In turn, the common RLC entity 510 is associated with a MAC layer/entity 515 (e.g., an implementation of the MAC sublayer 214).

Via upper layers, the PDCP layer/entity 505 receives a first QoS flow 430 (denoted “QoS flow #1”) with PSDB and/or PSER requirements. The data associated with the first QoS flow 430 includes a first PDU-Set 435, e.g., GTP-U data, having a first importance level (denoted “Importance_1”) and a first PDU-Set ID (denoted “PDU-Set ID_1”). The data associated with the first QoS flow 430 also includes a second PDU-Set 440, e.g., GTP-U data, having a second importance level (denoted “Importance_2”) and a second PDU-Set ID (denoted “PDU-Set ID_2”). The data associated with the first QoS flow 430 further includes a third PDU-Set 445, e.g., GTP-U data, having a third importance level (denoted “Importance_3”) and a third PDU-Set ID (denoted “PDU-Set ID_3”).

The PDCP layer/entity 505 routes the first PDU-Set 435 as PDCP PDU (set) 520, routes the second PDU-Set 440 as PDCP PDU (set) 525, and routes the third PDU-Set 445 as PDCP PDU (set) 530. Note that each PDCP PDU includes importance information. Thereafter, the MAC layer/entity 515 maps each PDU-Set to a LCH priority based on importance information, as described above.

According to one embodiment of the second solution, a BSR is triggered based on new data becoming available for transmission and this data has a higher priority than the priority of any other data which is available for transmission. According to one implementation of this embodiment, the priority of the data becoming available for transmission, e.g., arriving in the PDCP, which is used for the BSR triggering is determined based on the importance level associated with the data and the priority of the LCH to which the data is mapped.

In one example, the UE 206 determines the priority of the data according to a function of the importance level of the data, e.g., PDCP SDU, and the associated LCH priority. In a further example, the UE 206 (e.g., at the MAC layer/entity 515) determines the priority of the LCH associated with UL data for BSR triggering based on the configured logical channel priority and the importance level of the data.

In one implementation of the second solution, the LCH priority for BSR triggering is a function of the configured LCH priority and the importance level of the corresponding data, e.g., PDCP PDU/SDU. In one given example, the priority of the LCH for BSR triggering is determined as max (1, (configured LCH priority−1))—with 1 representing the highest LCH priority. For high importance data, the LCH priority used for BSR triggering is increased by one, i.e., an increasing priority value indicates a lower priority level. This new determination of LCH priority used for BSR triggering should ensure that a BSR is likely triggered when new UL data becomes available in the UE 206 for transmission which as a high importance level associated.

According to another implementation of the second solution, a BSR is triggered for cases when new UL data becomes available in the UE 206 for transmission which is high importance data regardless of the priority of any logical channel containing available UL data which belong to any LCG.

According to one embodiment of the second solution, when indicating a PDCP data volume to a MAC layer/entity 515 for BSR triggering and Buffer size calculation, the PDCP layer/entity 505 indicates the PDCP data volume per importance level to the MAC layer/entity 515. In one exemplary implementation, the buffer levels indicated in the BSR should indicate the amount of data per importance level, e.g., for each of the importance levels associated with a PDCP SDU/PDU a separate Buffer level is indicated within the BSR.

In another implementation, the UE 206 splits the data volume of the PDCP layer/entity 505 and RLC data volume in order to compute a data volume per importance level, i.e., data volume of the importance level corresponds to the sum of the RLC data volume per importance level and the amount of the PDCP data volume per importance level.

As an example, in the case where the bearer carries SDU/PDUs of 2 different importance levels-one for high importance data (I-frame) and another LCH for low importance data (P/B-frame)—the PDCP data volume as well as the RLC data volume is split in 2 parts, i.e., one corresponding to the high importance PDCP SDUs/PDUs and one accounting for the low importance PDCP SDUs/PDUs. In one example, a new BSR MAC CE format is introduced where the buffer status is indicated per importance level for an LCH/LCG.

According to one embodiment, new signaling indicates to the MAC layer/entity 515 of the UE 206 whether importance level associated of a PDU/SDU should be considered while performing the Logical Channel Prioritization (LCP) procedure. In one implementation of the embodiment, the new gNB-to-UE signaling is carried within a new MAC CE.

According to one implementation of this embodiment, the new signaling indicates whether the priority of a LCH during the LCP procedure is a function of the configured LCH priority and the importance level of the data of the LCH or whether the priority of the LCH used during LCP procedure is just the configured LCH priority (as in legacy).

For cases when the signaling instructs the UE/MAC layer to consider not only the configured LCH priority but also the importance level of a PDU/SDU for the multiplexing and assembly procedure (e.g., LCP procedure), the UE 206 determines the LCH priority used during LCP as a function of the configured LCH priority and the importance level of the data of an LCH. In one example, the priority of the LCH used during LCP is the value indicated by the function max (1, (configured LCH priority−1)) for cases when the importance level of the data of a LCH being considered during LCP is “high importance”.

According to one embodiment of the second solution, the MAC layer/entity 515 of the UE 206 multiplexes only PDUs of PDU-Sets of a LCH having the same associated importance level in one transport block. Here, the UE 206 shall refrain from multiplexing PDUs/PDU-Sets of a LCH having different associated importance level into the same TB.

Because a different importance level may translate to a different QoS treatment for the air interface transmission, e.g., different PER, reliability (or Hybrid Automatic Repeat Request (HARQ)) operation point, etc., the multiplexing rules take according to this embodiment also the importance level associated with PDU/PDU-Set and potentially the PDU-Set boundaries into account. In one example, the UE shall not multiplex PDUs of different PDU-Sets for the same LCH into the same TB.

According to one implementation of the second solution, the MAC layer/entity 515 is only allowed to multiplex data of the same importance level into a TB, e.g., only data of LCHs having the same associated importance level are considered for the LCP/TB generation procedure.

According to another embodiment of the second solution, a new mapping/association between importance level and CG configuration is configured. For cases when PDUs/PDU-Sets of different importance levels are carried over a single common LCH, it will be beneficial to introduce some new mapping configuration which allows to have a finer granularity than the current LCH to CG mapping.

In the mapping option where I-frames and P-Frames are carried by the same LCH, the new mapping ensures that I-frames which have a different periodicity and frame size compared to P-frames are using a different CG configuration. This new mapping configuration is in one example considered during the LCP procedure, new sub-LCH restriction is applied during LCH selection, e.g., a LCH is only considered during LCP for a configured grant allocation when data of this LCH has an associated importance level which is in the list of allowed importance levels configured for the corresponding CG configuration.

In one example, a new configuration is introduced, e.g., RRC configuration, which configures for a CG configuration the list of importance levels. In another example, a new configuration is introduced, e.g., RRC configuration, which controls per importance level the list of allowed CG configurations.

In yet another example, a new configuration, e.g., RRC configuration, configures for a LCH the mapping between an importance level supported by the LCH and the list of allowed CG configurations, e.g., here the mapping between importance level and CG configuration(s) is LCH-specific.

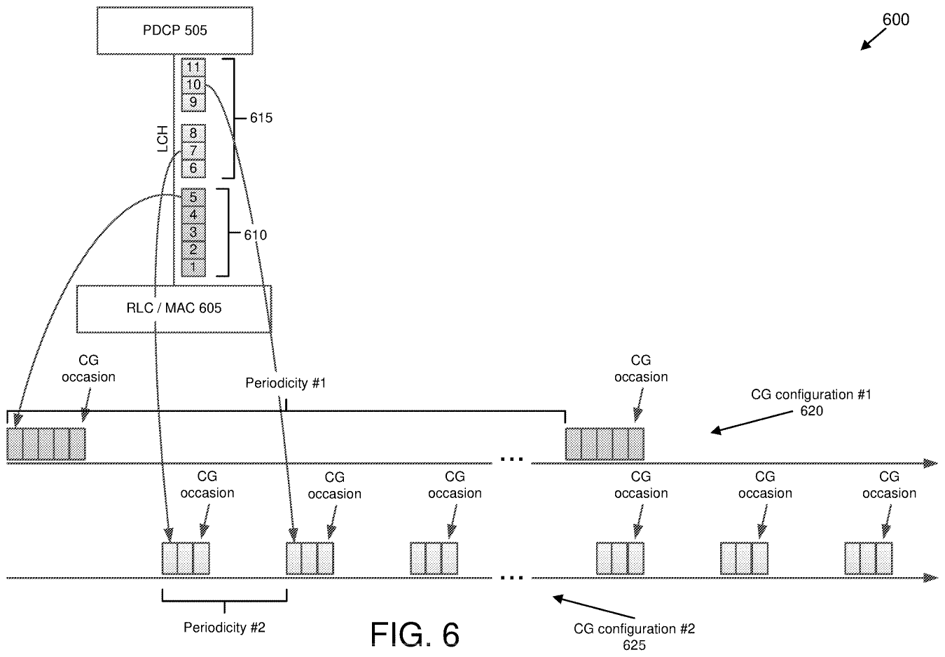

FIG. 6 depicts an exemplary procedure 600 for importance level to CG configuration mapping for a LCH, in accordance with aspects of the present disclosure. The procedure 600 involves a UE 206 having the PDCP layer/entity 505, and an RLC/MAC entity 605, representative of the common RLC entity 510 and the MAC layer/entity 515.

As shown in FIG. 6, the LCH in this example carries data of two different importance levels, i.e., data packets 610 representing PDUs with high importance (I-frame) and data packets 615 representing PDUs of lower importance (P-frame). The high importance data packets 610 (i.e., PDUs and/or SDUs) are mapped to a first CG configuration 620, whereas the low importance data packets/PDUs/SDUs are mapped to a second CG configuration 625. Here, it is assumed that the first CG configuration 620 is in the allowed list of CG configuration of the importance PDUs of the LCH. As depicted, the first CG configuration 620 has a first periodicity and include 5 CG occasions in each CG period, whereas the second CG configuration 625 has a second periodicity and includes 3 CG occasions in each respective CG period.

According to one embodiment, a new configured grant configuration is introduced which allows configuring different number of CG occasions per CG period. In one implementation of the embodiment the new CG configuration is used for XR services. For scenarios where data/PDUs of different importance levels are carried over the same common LCH, the new CG configuration ensures that the requirements of the different data types, e.g., I-frames and P-frames, are satisfied by a single CG configuration.

In one example, certain CG periods of the CG configuration may be configured with a larger number of CG occasions compared to other CG periods in order to accommodate the larger frame sizes of I-frames compared to P-frames. The benefit of having such flexibility to configure the number of CG occasions per CG period is that only one CG configuration may be needed to satisfy the requirements of different PDU-Sets, e.g. I-frames and P/B-frames.

In one example, the new CG configuration is comprised of a field configuring a list of CG occasion configurations. Each CG occasion configuration in the list corresponds to the CG occasions for a CG period in sequential order. The list of CG occasion configurations represents a pattern which is repeated with the given periodicity. For example, assuming a list with 3 CG occasion configurations, the first CG occasion configuration, e.g., defining the CG resources of the different CG occasions, would be used for the first CG period, the second CG occasion configuration would be used for the second CG period, the third CG occasion configuration for the third CG period, the first CG occasion configuration again for the fourth CG period and so on.

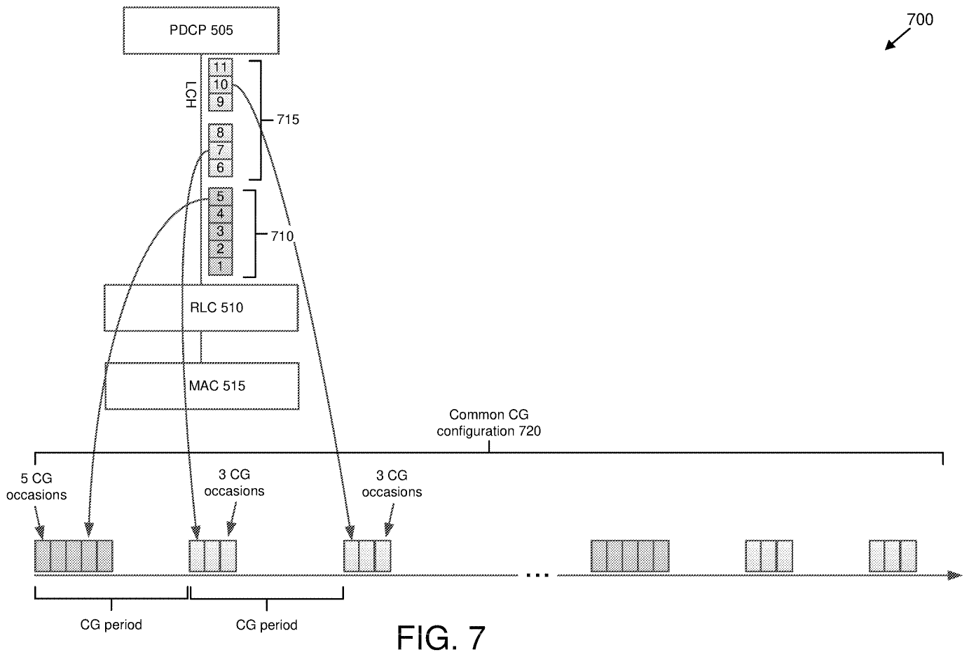

FIG. 7 depicts an exemplary procedure 700 for importance level to CG configuration mapping for a LCH, in accordance with aspects of the present disclosure. The procedure 700 involves a UE 206 having the PDCP layer/entity 505, the common RLC entity 510, and the MAC layer/entity 515.

As shown in FIG. 7, the LCH carries data of two different importance levels, i.e., data packets 710 representing PDUs with high importance (I-frame) and data packets 715 representing PDUs of lower importance (P-frame). However, the UE 206 has a common CG configuration 720 is shown, which supports two different CG occasion configurations, i.e., a first CG occasion configuration having 5 CG occasions within one CG period for transmitting higher importance data, e.g., an I-frame, and a second CG occasion configuration having 3 CG occasions within a CG period for transmission of lower importance data, e.g., P-frames.

According to one embodiment of the second solution, the common RLC entity 510 is aware of the importance of a RLC SDU delivered from the PDCP layer/entity 505. In various embodiments, the PDCP layer/entity 505 may indicate with every delivered PDCP PDU the associated importance level to the common RLC entity 510. According to one implementation of the embodiment, an RLC header is comprised of a new field indicating the importance level of a RLC PDU. The receiving RLC entity 510 may perform certain functionalities differently depending on the importance level of a received RLC PDU, e.g., reordering may be done considering the importance level of received RLC PDUs.

According to embodiments of a third solution, a RAN node 208 may provide congestion information to a UE 206, where the UE 206 adjusts handling of new data, e.g., new PDCP SDUs arriving at a PDCP layer from higher layer, based on the congestion information. Note that the embodiments of the third solution may be combined with those of the first solution or the second solution.

According to one embodiment of the third solution, a new signaling message is used to provide the UE with congestion information. In one implementation of the third solution, the congestion information provides information on the congestion level for the air interface, e.g., Uu interface. In one example, the information informs about congestion occurring on the air interface for the uplink.

According to one implementation of the third solution, the new message is signaled from the gNB to the UE. In one example, the new message is transmitted via a MAC control element. In one example, the message contains one of the following information or a combination thereof: A) an indication that there is/there is no longer congestion on the air interface (Uu interface) for UL/DL transmissions; B) the message activates/deactivates a “congestion mode” behavior in the UE; C) ordering the UE to discard PDUs available/pending in the UE for transmission of a certain importance level, e.g., indicating to discard low importance data in the case of congestion; D) ordering the UE to deprioritize the transmission of PDUs with a certain importance level, e.g., low importance data, in order to free up transmission resources for high importance PDUs; E) indicating the LCH ID for which UE should discard PDUs pending for transmission (this option is specifically for the split bearer mapping option-one PDCP entity associated with multiple RLC entities).

For real-time applications like real-time video application, PDUs pending in the UE for transmission corresponding to an older video frame are irrelevant to the real time video stream; there is no point in transmitting them any longer and those PDUs/SDUs can be dropped as described below. This will help ease congestion in the network while improving the end-user experience of the real time video stream.

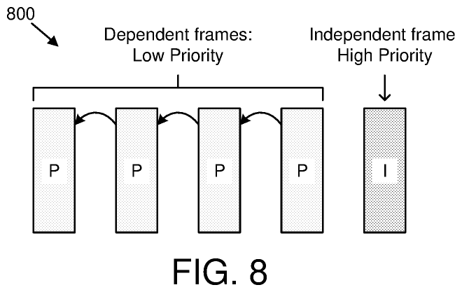

FIG. 8 depicts an exemplary data prioritization 800 for XR traffic, in accordance with aspects of the present disclosure. As shown in the figure for cases when new high priority data arrives in a UE 206's buffer and has been transmitted (I-frame) in the UL, there is no point in transmitting further pending low priority data (P-frame) which is dependent on the previous I-frame. In order to reduce the congestion level on the air interface, the UE 206 should discard the “outdated” low priority data and use the radio resources for the transmission of the PDUs/SDUs (P-frames) which are related to the current I-frame.

According to one embodiment of the third solution, in response to receiving an order from gNB to discard low importance data due to congestion, the UE 206 discards, e.g., PDUs in the buffer pending for transmission having a PDCP sequence number which is lower than the PDCP SN of the last PDU of the PDU-Set transmitted on the highest importance RLC channel (I-frame). Referring again to FIG. 8, when the UE 206 has transmitted the I-frame on the UL, i.e. PDUs of the PDU-Set associated with the I-frame which have been transmitted on the high importance LCH/RLC bearer, the UE 206 should delete those PDCP PDUs/SDUs which are associated with a low importance level having a PDCP SN which is lower than the last PDCP PDU of the PDU-Set carrying the I-frame, as those PDUs/SDUs would be related to the previous I-frame and hence of no use for the user experience.

According to one related embodiment of the third solution, upon reception of the new message providing information on the congestion on the air interface (e.g., for UL), the UE 206 switches to the “congestion mode”. In one example, the message activates the “congestion mode” in the UE 206. In one example, the UE behavior for cases when congestion mode has been activated, refers to the behavior where the UE 206 discards (or deprioritizes) packets pending in the UE 206 for transmission which are associated with an importance level which is lower than a predefined level, e.g., PDUs associated with a low importance level should be discarded (or deprioritized) by the UE 206 in order to free up resources for higher importance data.

Discarding or deprioritizing data which is not useful anymore, e.g., data PDUs of a previous frame while PDUs of a new frame have been already transmitted, is outlined above. A new discarding/deprioritization trigger, i.e., based on explicit signaling by gNB, is introduced according to this embodiment. Under current 3GPP specifications, discarding of data PDUs is done based on timer expiry, or duplication discarding is done based on acknowledgment of successful data transmission. In contrast, in the third solution, the UE 206 triggers the discarding based on some explicit network (e.g., RAN) indication.

According to one embodiment, the UE 206 performs discarding of certain PDUs in case of a detected congestion on the Uu interface, e.g., for UL transmissions, when the additional discarding is enabled by the network. The network (e.g., RAN) explicitly enables/disables the discarding (or deprioritization) functionality (e.g., considering the importance/PSI level of a PDU/PDU set) in case of congestion, e.g., by means of a MAC CE activating/deactivating the discarding functionality in case of congestion.

According to embodiments of a fourth solution, a UE 206 may use a predefined BSR MAC CE format when a BSR has been triggered for one of a set of predefined LCGs/LCHs. Note that the embodiments of the fourth solution may be combined with those of the first solution, the second solution, and/or the third solution.

According to one embodiment of the fourth solution, a UE 206 uses a predefined BSR MAC CE format when a BSR has been triggered for one of a set of predefined LCGs/LCHs. According to one implementation of the embodiment, the UE 206 uses a BSR MAC CE format defined for XR services in case a BSR was triggered for an LCG/LCH which is configured as a XR-specific LCG/LCH.

In one example, the network configures, e.g., using RRC signaling, whether a LCH/LCG carries XR traffic. In another example, the network configures whether a radio bearer, e.g., DRB, carries XR traffic. A new bearer type is introduced, e.g., XR-bearer, which may have certain associated characteristics or handling different to non-XR bearers.

According to one implementation of the fourth solution, different BSR triggers may be defined for XR-bearer/LCH(s). In addition to the legacy specified BSR trigger, there might be additional XR-specific trigger which only apply for XR-bearer/LCH(s).

According to one embodiment of the fourth solution, an XR-specific BSR procedure is introduced which may be configured by the network, e.g., RRC signaling, in addition to the legacy BSR procedure. The UE 206 uses a XR buffer status reporting procedure to provide the RAN node 208 (e.g., gNB) with the information about the amount of the XR data available for transmission and potentially some information related to the buffering delay associated with the XR data, e.g., remaining delay budget for the data being available for transmission. In one example, an XR-specific BSR may also provide information on the importance of the data being available for transmission.

According to another implementation of the fourth solution, the XR BSR reports only data of predefined LCGs which are configured to carry XR services. Those predefined LCGs may be comprised only of XR-bearers/LCHs.

According to another embodiment of the fourth solution, an XR-BSR, e.g., BSR customized for XR traffic, is conveyed in a MAC CE which has a different format than a legacy BSR MAC CE, i.e., Long/short (truncated) BSR MAC CE as defined in 3GPP TS 38.321. The different MAC CE format for the XR BSR allows reporting the buffer status with a different granularity compared to a legacy BSR, e.g., regular long/short BSR. The XR BSR MAC CE is identified by a new reserved logical channel ID.

According to another embodiment an “XR BSR” is a new type of BSR MAC CE defined in specifications addition to the BSR formats already specified for legacy NR, i.e., Short BSR format, Long BSR format, Short Truncated BSR format and Long Truncated BSR format. The new BSR format, i.e., referred to as “XR BSR,” is identified by a new reserved Logical Channel Identifier (LCID). Introducing the “XR BSR” as a new type of BSR MAC CE (e.g., identified by a new reserved LCID) allows a RAN node 208 to unambiguously identify a received BSR as an “XR BSR,” i.e., BSR which was triggered based on XR data arrival.

According to one embodiment of the fourth solution, the RAN node 208 (e.g., gNB) may configure the UE 206 with a XR-specific BSR configuration. According to one implementation of this embodiment, the UE 206 might be configured with different BSR timer configuration compared to the legacy BSR-related timer, e.g., timer values might be different.

According to a further embodiment of the fourth solution, a triggered XR-BSR shall be cancelled when the UL grant(s) can accommodate all pending data available for transmission, e.g., data of XR-bearers/LCHs as well as data of non-XR bearer/LCHs but is not sufficient to additionally accommodate the XR-BSR MAC CE plus its subheader.

According to another embodiment of the fourth solution, the transmission of an XR-BSR MAC CE shall not cancel other legacy triggered BSR(s), i.e., triggered legacy (regular) BSR.

A MAC PDU shall contain at most one XR BSR MAC CE, even when multiple events have triggered a XR BSR.

All triggered XR BSR(s) shall be cancelled when a MAC PDU is transmitted and this PDU includes the corresponding XR BSR MAC CE.

According to another embodiment of the fourth solution, the MAC entity of a UE 206 considers that UL-SCH resources available for a new transmission always meet the LCP mapping restrictions (see subclause 5.4.3.1 of 3GPP TS 38.321) configured for the logical channel(s) that triggered an XR BSR. As a consequence, the UE 206 should not trigger a Scheduling Request in case an XR BSR was triggered at the MAC entity of the UE 206 and UL-SCH resources are available for a new transmission.

According to yet another embodiment of the fourth solution, the relative priority of an XR BSR during LCP procedure is the same as a regular BSR or a periodic BSR.

According to one embodiment of the fourth solution, XR-specific SR configurations may be configured by the network, e.g., by means of RRC signaling. Such XR-specific SR configurations allow the RAN node 208 (e.g., gNB) to distinguish between BSR(s) triggered due to XR data arrival and non-XR data arrival, e.g., data on XR-LCHs becomes available for transmission. According to one implementation of the embodiment, only XR-bearer/LCH(s) can be mapped to SR configurations reserved for XR.

According to one embodiment, the BSR triggering conditions only take into account the buffer status of the LCH(s)/LCG(s) configured for XR services. According to one implementation of the embodiment, the UE 206 triggers a XR-BSR for cases when UL data becomes available for a XR-LCH, and this UL data belongs to a LCH with higher priority than the priority of any XR-LCH containing UL data or when none of the XR-LCH contains any available UL data. In one example, a XR-BSR may be triggered when new XR data becomes available and there is no data for the other XR-LCHs but some higher priority data for a non-XR LCH.

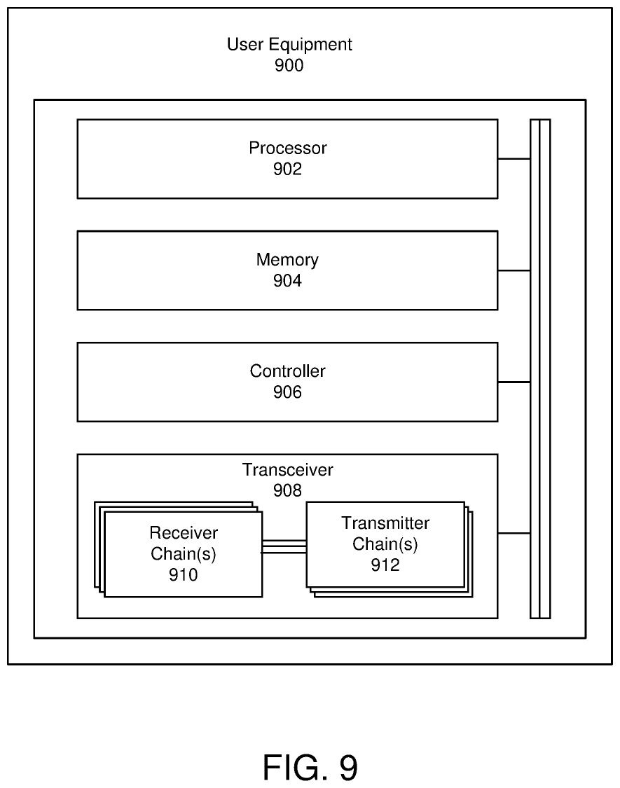

FIG. 9 illustrates an example of a UE 900 in accordance with aspects of the present disclosure. The UE 900 may include a processor 902, a memory 904, a controller 906, and a transceiver 908. The processor 902, the memory 904, the controller 906, or the transceiver 908, or various combinations thereof or various components thereof may be examples of means for performing various aspects of the present disclosure as described herein. These components may be coupled (e.g., operatively, communicatively, functionally, electronically, electrically) via one or more interfaces.

The processor 902, the memory 904, the controller 906, or the transceiver 908, or various combinations or components thereof may be implemented in hardware (e.g., circuitry). The hardware may include a processor, a digital signal processor (DSP), an application-specific integrated circuit (ASIC), or other programmable logic device, or any combination thereof configured as or otherwise supporting a means for performing the functions described in the present disclosure.

The processor 902 may include an intelligent hardware device (e.g., a general-purpose processor, a DSP, a CPU, an ASIC, a Field Programable Gate Array (FPGA), or any combination thereof). In some implementations, the processor 902 may be configured to operate the memory 904. In some other implementations, the memory 904 may be integrated into the processor 902. The processor 902 may be configured to execute computer-readable instructions stored in the memory 904 to cause the UE 900 to perform various functions of the present disclosure.

The memory 904 may include volatile or non-volatile memory. The memory 904 may store computer-readable, computer-executable code including instructions when executed by the processor 902 cause the UE 900 to perform various functions described herein. The code may be stored in a non-transitory computer-readable medium such the memory 904 or another type of memory. Computer-readable media includes both non-transitory computer storage media and communication media including any medium that facilitates transfer of a computer program from one place to another. A non-transitory storage medium may be any available medium that may be accessed by a general-purpose or special-purpose computer.

In some implementations, the processor 902 and the memory 904 coupled with the processor 902 may be configured to cause the UE 900 to perform one or more of the UE functions described herein (e.g., executing, by the processor 902, instructions stored in the memory 904). For example, the processor 902 may support wireless communication at the UE 900 in accordance with examples as disclosed herein. The UE 900 may be configured to support a means for detecting a trigger for buffer status reporting for a set of predefined logical channels (e.g., LCHs or LCGs). The UE 900 may be configured to or operable to support a means for generating a BSR for the set of predefined logical channels and for transmitting the BSR to a RAN, where the BSR uses a predefined format.

In some implementations, the UE 900 is configured to receive a LCH configuration from the RAN, the LCH configuration indicating whether a particular logical channel is configured for XR traffic. In some implementations, the UE 900 is configured to receive a radio bearer (RB) configuration from the RAN, the RB configuration indicating whether a particular DRB is configured for XR traffic.

In some implementations, the UE 900 is configured to receive a BSR configuration from the RAN, the BSR configuration indicating an additional XR-specific condition applicable to the set of predefined logical channels. In such implementations, detecting the trigger for buffer status reporting includes the UE 900 determining whether a common BSR trigger is detected and/or the XR-specific condition is met. In certain implementations, the BSR configuration indicates an XR-specific BSR timer having an associated timer value different than what is configured for non-XR buffer status reporting.

In some implementations, the set of predefined logical channels is configured for XR traffic, where the predefined format includes an XR-specific BSR format. In certain implementations, the BSR indicates an amount of XR data available for transmission and further indicates buffering delay information associated with the XR data available for transmission.

In certain implementations, the buffering delay information includes a remaining packet delay budget for the XR data available for transmission. In further implementations, the BSR may indicate an importance level of the XR data available for transmission.

In some implementations, the BSR uses an XR-specific logical channel ID. In certain implementations, the XR-specific logical channel ID includes a reserved logical channel ID (i.e., a reserved value in 3GPP Rel-17). In some implementations, the UE 900 is configured to maintain (i.e., not cancel) a pending non-XR BSR trigger in response to transmitting the BSR using the XR-specific format.

In some implementations, the UE 900 is configured to receive an UL grant and to determine whether the UL grant can accommodate all pending data available for transmission including data for the set of predefined logical channels (i.e., data of XR-bearers/LCHs). In such implementations, the UE 900 is configured to cancel a triggered XR-specific BSR in response to determining that the UL grant can accommodate all pending data available for transmission. In certain implementations, the UE 900 is configured to cancel the triggered XR-specific BSR in response to determining that the UL grant can accommodate all pending data available for transmission but is not sufficient to additionally accommodate the XR-BSR MAC CE plus its subheader.

In some implementations, the UE 900 is configured to treat UL-SCH resources available for a new transmission as satisfying the LCP mapping restrictions configured for the set of predefined logical channels (e.g., XR-bearers/LCHs). In some implementations, the UE 900 is configured to receive an XR-specific SR configuration corresponding to the set of predefined logical channels, the XR-specific SR configuration indicating a set of SR resources for XR traffic.

The controller 906 may manage input and output signals for the UE 900. The controller 906 may also manage peripherals not integrated into the UE 900. In some implementations, the controller 906 may utilize an operating system (OS) such as iOS®, ANDROID®, WINDOWS®, or other operating systems (OSes). In some implementations, the controller 906 may be implemented as part of the processor 902.

In some implementations, the UE 900 may include at least one transceiver 908. In some other implementations, the UE 900 may have more than one transceiver 908. The transceiver 908 may represent a wireless transceiver. The transceiver 908 may include one or more receiver chains 910, one or more transmitter chains 912, or a combination thereof.

A receiver chain 910 may be configured to receive signals (e.g., control information, data, packets) over a wireless medium. For example, the receiver chain 910 may include one or more antennas for receiving the signal over the air or wireless medium. The receiver chain 910 may include at least one amplifier (e.g., a low-noise amplifier (LNA)) configured to amplify the received signal. The receiver chain 910 may include at least one demodulator configured to demodulate the receiving signal and obtain the transmitted data by reversing the modulation technique applied during transmission of the signal. The receiver chain 910 may include at least one decoder for decoding and processing the demodulated signal to receive the transmitted data.

A transmitter chain 912 may be configured to generate and transmit signals (e.g., control information, data, packets). The transmitter chain 912 may include at least one modulator for modulating data onto a carrier signal, preparing the signal for transmission over a wireless medium. The at least one modulator may be configured to support one or more techniques such as amplitude modulation (AM), frequency modulation (FM), or digital modulation schemes like phase-shift keying (PSK) or quadrature amplitude modulation (QAM). The transmitter chain 912 may also include at least one power amplifier configured to amplify the modulated signal to an appropriate power level suitable for transmission over the wireless medium. The transmitter chain 912 may also include one or more antennas for transmitting the amplified signal into the air or wireless medium.

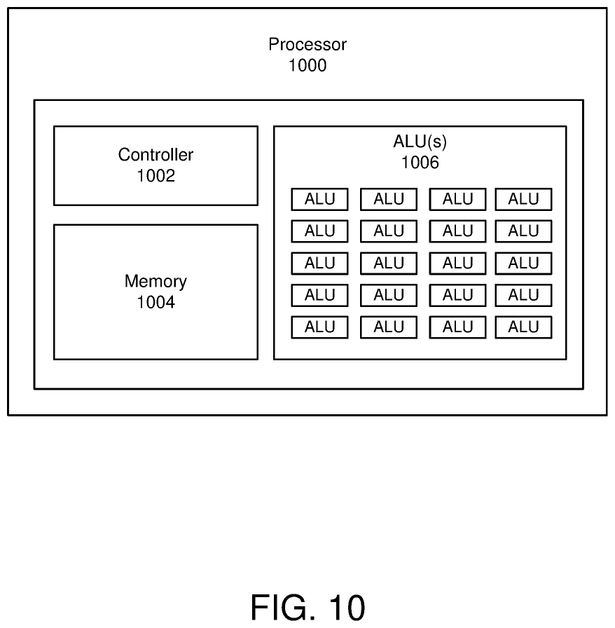

FIG. 10 illustrates an example of a processor 1000 in accordance with aspects of the present disclosure. The processor 1000 may be an example of a processor configured to perform various operations in accordance with examples as described herein. The processor 1000 may include a controller 1002 configured to perform various operations in accordance with examples as described herein. The processor 1000 may optionally include at least one memory 1004, which may be, for example, an L1/L2/L3 cache. Additionally, or alternatively, the processor 1000 may optionally include one or more arithmetic-logic units (ALUs) 1006. One or more of these components may be in electronic communication or otherwise coupled (e.g., operatively, communicatively, functionally, electronically, electrically) via one or more interfaces (e.g., buses).

The processor 1000 may be a processor chipset and include a protocol stack (e.g., a software stack) executed by the processor chipset to perform various operations (e.g., receiving, obtaining, retrieving, transmitting, outputting, forwarding, storing, determining, identifying, accessing, writing, reading) in accordance with examples as described herein. The processor chipset may include one or more cores, one or more caches (e.g., memory local to or included in the processor chipset (e.g., the processor 1000) or other memory (e.g., random access memory (RAM), read-only memory (ROM), dynamic RAM (DRAM), synchronous dynamic RAM (SDRAM), static RAM (SRAM), ferroelectric RAM (FeRAM), magnetic RAM (MRAM), resistive RAM (RRAM), flash memory, phase change memory (PCM), and others).

The controller 1002 may be configured to manage and coordinate various operations (e.g., signaling, receiving, obtaining, retrieving, transmitting, outputting, forwarding, storing, determining, identifying, accessing, writing, reading) of the processor 1000 to cause the processor 1000 to support various operations in accordance with examples as described herein. For example, the controller 1002 may operate as a control unit of the processor 1000, generating control signals that manage the operation of various components of the processor 1000. These control signals include enabling or disabling functional units, selecting data paths, initiating memory access, and coordinating timing of operations.

The controller 1002 may be configured to fetch (e.g., obtain, retrieve, receive) instructions from the memory 1004 and determine subsequent instruction(s) to be executed to cause the processor 1000 to support various operations in accordance with examples as described herein. The controller 1002 may be configured to track memory address of instructions associated with the memory 1004. The controller 1002 may be configured to decode instructions to determine the operation to be performed and the operands involved. For example, the controller 1002 may be configured to interpret the instruction and determine control signals to be output to other components of the processor 1000 to cause the processor 1000 to support various operations in accordance with examples as described herein. Additionally, or alternatively, the controller 1002 may be configured to manage flow of data within the processor 1000. The controller 1002 may be configured to control transfer of data between registers, arithmetic logic units (ALUs), and other functional units of the processor 1000.

The memory 1004 may include one or more caches (e.g., memory local to or included in the processor 1000 or other memory, such RAM, ROM, DRAM, SDRAM, SRAM, MRAM, flash memory, etc. In some implementations, the memory 1004 may reside within or on a processor chipset (e.g., local to the processor 1000). In some other implementations, the memory 1004 may reside external to the processor chipset (e.g., remote to the processor 1000).

The memory 1004 may store computer-readable, computer-executable code including instructions that, when executed by the processor 1000, cause the processor 1000 to perform various functions described herein. The code may be stored in a non-transitory computer-readable medium such as system memory or another type of memory. The controller 1002 and/or the processor 1000 may be configured to execute computer-readable instructions stored in the memory 1004 to cause the processor 1000 to perform various functions. For example, the processor 1000 and/or the controller 1002 may be coupled with or to the memory 1004, the processor 1000, the controller 1002, and the memory 1004 may be configured to perform various functions described herein. In some examples, the processor 1000 may include multiple processors and the memory 1004 may include multiple memories. One or more of the multiple processors may be coupled with one or more of the multiple memories, which may, individually or collectively, be configured to perform various functions herein.

The one or more ALUs 1006 may be configured to support various operations in accordance with examples as described herein. In some implementations, the one or more ALUs 1006 may reside within or on a processor chipset (e.g., the processor 1000). In some other implementations, the one or more ALUs 1006 may reside external to the processor chipset (e.g., the processor 1000). One or more ALUs 1006 may perform one or more computations such as addition, subtraction, multiplication, and division on data. For example, one or more ALUs 1006 may receive input operands and an operation code, which determines an operation to be executed. One or more ALUs 1006 be configured with a variety of logical and arithmetic circuits, including adders, subtractors, shifters, and logic gates, to process and manipulate the data according to the operation. Additionally, or alternatively, the one or more ALUs 1006 may support logical operations such as AND, OR, exclusive-OR (XOR), not-OR (NOR), and not-AND (NAND), enabling the one or more ALUs 1006 to handle conditional operations, comparisons, and bitwise operations.

The processor 1000 may support wireless communication in accordance with examples as disclosed herein. For example, the processor 1000 may perform one or more of the UE functions described herein. The processor 1000 may be configured to or operable to support a means for detecting a trigger for buffer status reporting for a set of predefined logical channels (e.g., LCHs or LCGs). The processor 1000 may be configured to or operable to support a means for generating a BSR for the set of predefined logical channels and for transmitting the BSR to a RAN, where the BSR uses a predefined format.

In some implementations, the processor 1000 is configured to receive a LCH configuration from the RAN, the LCH configuration indicating whether a particular logical channel is configured for XR traffic. In some implementations, the processor 1000 is configured to receive an RB configuration from the RAN, the RB configuration indicating whether a particular DRB is configured for XR traffic.

In some implementations, the processor 1000 is configured to receive a BSR configuration from the RAN, the BSR configuration indicating an additional XR-specific condition applicable to the set of predefined logical channels. In such implementations, detecting the trigger for buffer status reporting includes the processor 1000 determining whether a common BSR trigger is detected and/or the XR-specific condition is met. In certain implementations, the BSR configuration indicates an XR-specific BSR timer having an associated timer value different than what is configured for non-XR buffer status reporting.

In some implementations, the set of predefined logical channels is configured for XR traffic, where the predefined format includes an XR-specific BSR format. In certain implementations, the BSR indicates an amount of XR data available for transmission and further indicates buffering delay information associated with the XR data available for transmission.

In certain implementations, the buffering delay information includes a remaining packet delay budget for the XR data available for transmission. In further implementations, the BSR may indicate an importance level of the XR data available for transmission.

In some implementations, the BSR uses an XR-specific logical channel ID. In certain implementations, the XR-specific logical channel ID includes a reserved logical channel ID (i.e., a reserved value in 3GPP Rel-17). In some implementations, the processor 1000 is configured to maintain (i.e., not cancel) a pending non-XR BSR trigger in response to transmitting the BSR using the XR-specific format.

In some implementations, the processor 1000 is configured to receive an UL grant and to determine whether the UL grant can accommodate all pending data available for transmission including data for the set of predefined logical channels (i.e., data of XR-bearers/LCHs). In such implementations, the processor 1000 is configured to cancel a triggered XR-specific BSR in response to determining that the UL grant can accommodate all pending data available for transmission. In certain implementations, the processor 1000 is configured to cancel the triggered XR-specific BSR in response to determining that the UL grant can accommodate all pending data available for transmission but is not sufficient to additionally accommodate the XR-BSR MAC CE plus its subheader.

In some implementations, the processor 1000 is configured to treat UL-SCH resources available for a new transmission as satisfying the LCP mapping restrictions configured for the set of predefined logical channels (e.g., XR-bearers/LCHs). In some implementations, the processor 1000 is configured to receive an XR-specific SR configuration corresponding to the set of predefined logical channels, the XR-specific SR configuration indicating a set of SR resources for XR traffic.

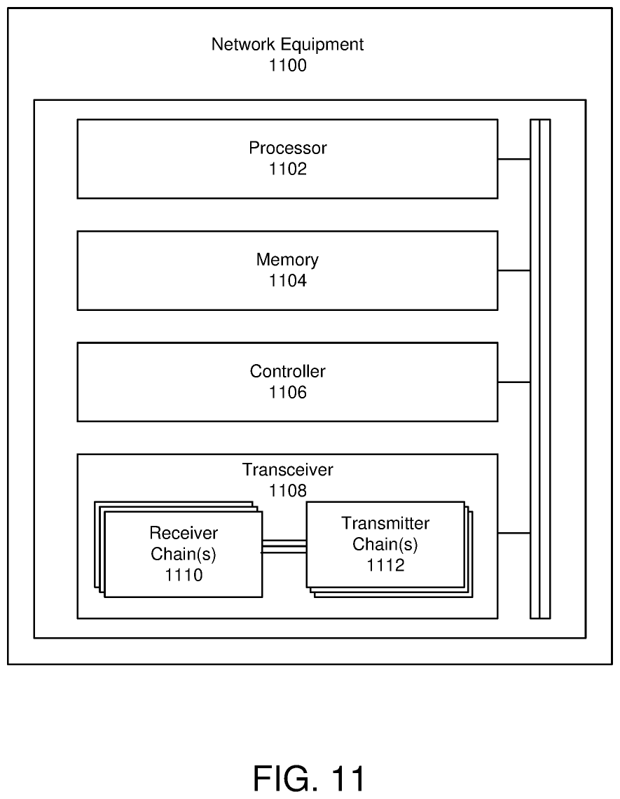

FIG. 11 illustrates an example of a NE 1100 in accordance with aspects of the present disclosure. The NE 1100 may include a processor 1102, a memory 1104, a controller 1106, and a transceiver 1108. The processor 1102, the memory 1104, the controller 1106, or the transceiver 1108, or various combinations thereof or various components thereof may be examples of means for performing various aspects of the present disclosure as described herein. These components may be coupled (e.g., operatively, communicatively, functionally, electronically, electrically) via one or more interfaces.

The processor 1102, the memory 1104, the controller 1106, or the transceiver 1108, or various combinations or components thereof may be implemented in hardware (e.g., circuitry). The hardware may include a processor, a digital signal processor (DSP), an application-specific integrated circuit (ASIC), or other programmable logic device, or any combination thereof configured as or otherwise supporting a means for performing the functions described in the present disclosure.

The processor 1102 may include an intelligent hardware device (e.g., a general-purpose processor, a DSP, a CPU, an ASIC, an FPGA, or any combination thereof). In some implementations, the processor 1102 may be configured to operate the memory 1104. In some other implementations, the memory 1104 may be integrated into the processor 1102. The processor 1102 may be configured to execute computer-readable instructions stored in the memory 1104 to cause the NE 1100 to perform various functions of the present disclosure.

The memory 1104 may include volatile or non-volatile memory. The memory 1104 may store computer-readable, computer-executable code including instructions when executed by the processor 1102 cause the NE 1100 to perform various functions described herein. The code may be stored in a non-transitory computer-readable medium such the memory 1104 or another type of memory. Computer-readable media includes both non-transitory computer storage media and communication media including any medium that facilitates transfer of a computer program from one place to another. A non-transitory storage medium may be any available medium that may be accessed by a general-purpose or special-purpose computer.

In some implementations, the processor 1102 and the memory 1104 coupled with the processor 1102 may be configured to cause the NE 1100 to perform one or more of the functions described herein (e.g., executing, by the processor 1102, instructions stored in the memory 1104). For example, the processor 1102 may support wireless communication at the NE 1100 in accordance with examples as disclosed herein.

The controller 1106 may manage input and output signals for the NE 1100. The controller 1106 may also manage peripherals not integrated into the NE 1100. In some implementations, the controller 1106 may utilize an OS such as iOS®, ANDROID®, WINDOWS®, or other OSes. In some implementations, the controller 1106 may be implemented as part of the processor 1102.

In some implementations, the NE 1100 may include at least one transceiver 1108. In some other implementations, the NE 1100 may have more than one transceiver 1108. The transceiver 1108 may represent a wireless transceiver. The transceiver 1108 may include one or more receiver chains 1110, one or more transmitter chains 1112, or a combination thereof.

A receiver chain 1110 may be configured to receive signals (e.g., control information, data, packets) over a wireless medium. For example, the receiver chain 1110 may include one or more antennas for receiving the signal over the air or wireless medium. The receiver chain 1110 may include at least one amplifier (e.g., a low-noise amplifier (LNA)) configured to amplify the received signal. The receiver chain 1110 may include at least one demodulator configured to demodulate the receiving signal and obtain the transmitted data by reversing the modulation technique applied during transmission of the signal. The receiver chain 1110 may include at least one decoder for decoding and processing the demodulated signal to receive the transmitted data.

A transmitter chain 1112 may be configured to generate and transmit signals (e.g., control information, data, packets). The transmitter chain 1112 may include at least one modulator for modulating data onto a carrier signal, preparing the signal for transmission over a wireless medium. The at least one modulator may be configured to support one or more techniques such as amplitude modulation (AM), frequency modulation (FM), or digital modulation schemes like phase-shift keying (PSK) or quadrature amplitude modulation (QAM). The transmitter chain 1112 may also include at least one power amplifier configured to amplify the modulated signal to an appropriate power level suitable for transmission over the wireless medium. The transmitter chain 1112 may also include one or more antennas for transmitting the amplified signal into the air or wireless medium.

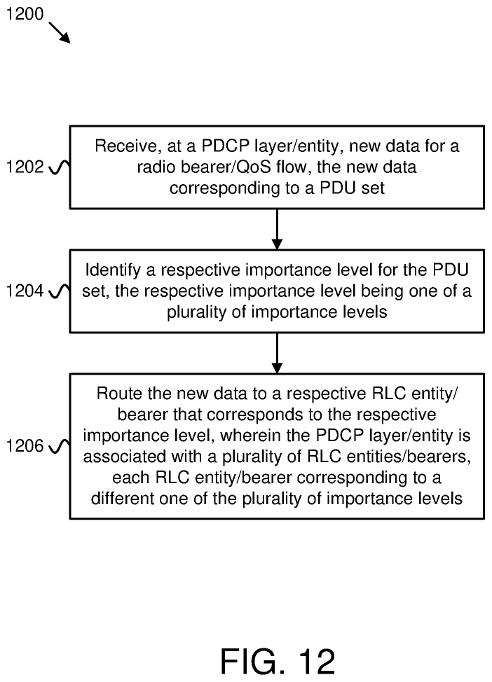

FIG. 12 illustrates a flowchart of a method 1200 in accordance with aspects of the present disclosure. The operations of the method 1200 may be implemented by a UE as described herein. In some implementations, the UE may execute a set of instructions to control the function elements of the UE to perform the described functions.

At Step 1202, the method 1200 may include receiving, at a PDCP layer/entity, new data for a radio bearer/QoS flow. Here, the new data corresponds to a PDU-Set. The operations of Step 1202 may be performed in accordance with examples as described herein. In some implementations, aspects of the operations of Step 1202 may be performed by a UE as described with reference to FIG. 9.

At Step 1204, the method 1200 may include identifying a respective importance level for the PDU-Set, the respective importance level being one of a plurality of importance levels. The operations of Step 1204 may be performed in accordance with examples as described herein. In some implementations, aspects of the operations of Step 1204 may be performed by a UE as described with reference to FIG. 9.

At Step 1206, the method 1200 may include routing the new data to a respective RLC entity/bearer that corresponds to the respective importance level. Here, the PDCP layer/entity is associated with a plurality of RLC entities/bearers, where each RLC entity/bearer corresponds to a different one of the plurality of importance levels. The operations of Step 1206 may be performed in accordance with examples as described herein. In some implementations, aspects of the operations of Step 1206 may be performed by a UE as described with reference to FIG. 9.

It should be noted that the method 1200 described herein describes one possible implementation, and that the operations and the steps may be rearranged or otherwise modified and that other implementations are possible.

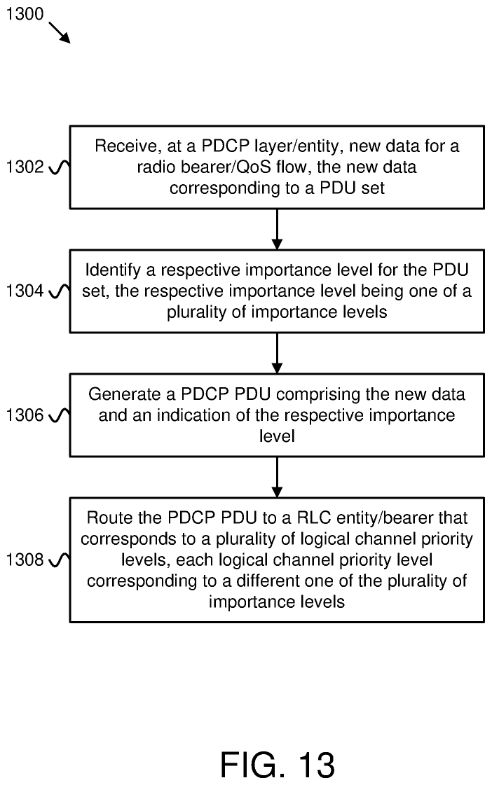

FIG. 13 illustrates a flowchart of a method 1300 in accordance with aspects of the present disclosure. The operations of the method 1300 may be implemented by a UE as described herein. In some implementations, the UE may execute a set of instructions to control the function elements of the UE to perform the described functions.

At Step 1302, the method 1300 may include receiving, at a PDCP layer/entity, new data for a radio bearer/QoS flow. Here, the new data corresponds to a PDU-Set. The operations of Step 1302 may be performed in accordance with examples as described herein. In some implementations, aspects of the operations of Step 1302 may be performed by a UE as described with reference to FIG. 9.

At Step 1304, the method 1300 may include identifying a respective importance level for the PDU-Set, the respective importance level being one of a plurality of importance levels. The operations of Step 1304 may be performed in accordance with examples as described herein. In some implementations, aspects of the operations of Step 1304 may be performed by a UE as described with reference to FIG. 9.

At Step 1306, the method 1300 may include generating a PDCP PDU including the new data and an indication of the respective importance level. The operations of Step 1306 may be performed in accordance with examples as described herein. In some implementations, aspects of the operations of Step 1306 may be performed by a UE as described with reference to FIG. 9.

At Step 1308, the method 1300 may include routing the PDCP PDU to a RLC entity/bearer that corresponds to a plurality of logical channel priority levels. Here, each logical channel priority level corresponds to a different one of the plurality of importance levels. The operations of Step 1308 may be performed in accordance with examples as described herein. In some implementations, aspects of the operations of Step 1308 may be performed by a UE as described with reference to FIG. 9.

It should be noted that the method 1300 described herein describes one possible implementation, and that the operations and the steps may be rearranged or otherwise modified and that other implementations are possible.

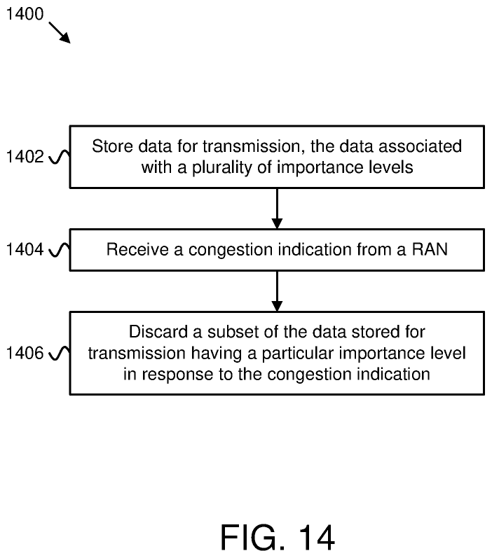

FIG. 14 illustrates a flowchart of a method 1400 in accordance with aspects of the present disclosure. The operations of the method 1400 may be implemented by a UE as described herein. In some implementations, the UE may execute a set of instructions to control the function elements of the UE to perform the described functions.

At Step 1402, the method 1400 may include storing data for transmission, where the data is associated with a plurality of importance levels. The operations of Step 1402 may be performed in accordance with examples as described herein. In some implementations, aspects of the operations of Step 1402 may be performed by a UE as described with reference to FIG. 9.

At Step 1404, the method 1400 may include receiving a congestion indication from a RAN. The operations of Step 1404 may be performed in accordance with examples as described herein. In some implementations, aspects of the operations of Step 1404 may be performed by a UE as described with reference to FIG. 9.

At Step 1406, the method 1400 may include discarding a subset of the data stored for transmission having a particular importance level in response to the congestion indication. The operations of Step 1406 may be performed in accordance with examples as described herein. In some implementations, aspects of the operations of Step 1406 may be performed by a UE as described with reference to FIG. 9.

It should be noted that the method 1400 described herein describes one possible implementation, and that the operations and the steps may be rearranged or otherwise modified and that other implementations are possible.

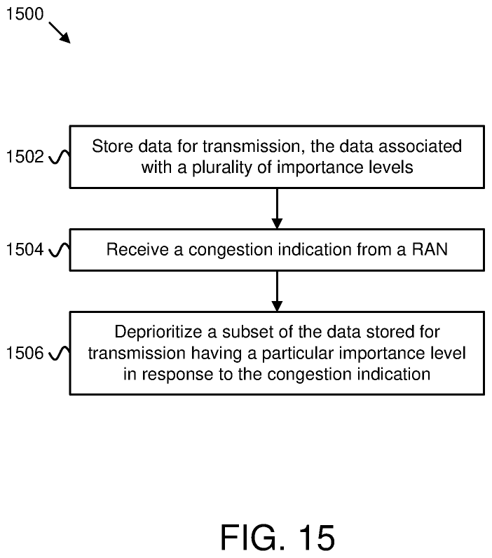

FIG. 15 illustrates a flowchart of a method 1500 in accordance with aspects of the present disclosure. The operations of the method 1500 may be implemented by a UE as described herein. In some implementations, the UE may execute a set of instructions to control the function elements of the UE to perform the described functions.

At Step 1502, the method 1500 may include storing data for transmission, where the data is associated with a plurality of importance levels. The operations of Step 1502 may be performed in accordance with examples as described herein. In some implementations, aspects of the operations of Step 1502 may be performed by a UE as described with reference to FIG. 9.

At Step 1504, the method 1500 may include receiving a congestion indication from a RAN. The operations of Step 1504 may be performed in accordance with examples as described herein. In some implementations, aspects of the operations of Step 1504 may be performed by a UE as described with reference to FIG. 9.

At Step 1506, the method 1500 may include deprioritizing a subset of the data stored for transmission having a particular importance level in response to the congestion indication. The operations of Step 1506 may be performed in accordance with examples as described herein. In some implementations, aspects of the operations of Step 1506 may be performed by a UE as described with reference to FIG. 9.

It should be noted that the method 1500 described herein describes one possible implementation, and that the operations and the steps may be rearranged or otherwise modified and that other implementations are possible.

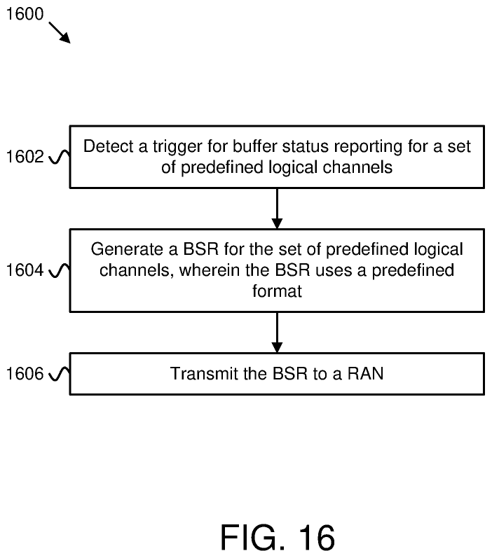

FIG. 16 illustrates a flowchart of a method 1600 in accordance with aspects of the present disclosure. The operations of the method 1600 may be implemented by a UE as described herein. In some implementations, the UE may execute a set of instructions to control the function elements of the UE to perform the described functions.

At Step 1602, the method 1600 may include detecting a trigger for buffer status reporting for a set of predefined logical channels (e.g., LCHs or LCGs). The operations of Step 1602 may be performed in accordance with examples as described herein. In some implementations, aspects of the operations of Step 1602 may be performed by a UE as described with reference to FIG. 9.

At Step 1604, the method 1600 may include generating a BSR for the set of predefined logical channels. The operations of Step 1604 may be performed in accordance with examples as described herein. In some implementations, aspects of the operations of Step 1604 may be performed by a UE as described with reference to FIG. 9.

At Step 1606, the method 1600 may include transmitting the BSR to a RAN, where the BSR uses a predefined format. The operations of Step 1606 may be performed in accordance with examples as described herein. In some implementations, aspects of the operations of Step 1606 may be performed by a UE as described with reference to FIG. 9.

It should be noted that the method 1600 described herein describes one possible implementation, and that the operations and the steps may be rearranged or otherwise modified and that other implementations are possible.

The description herein is provided to enable a person having ordinary skill in the art to make or use the disclosure. Various modifications to the disclosure will be apparent to a person having ordinary skill in the art, and the generic principles defined herein may be applied to other variations without departing from the scope of the disclosure. Thus, the disclosure is not limited to the examples and designs described herein but is to be accorded the broadest scope consistent with the principles and novel features disclosed herein.

1. A user equipment (UE) for wireless communication, comprising:
at least one memory; and
at least one processor coupled with the at least one memory and configured to cause the UE to:
detect a trigger for buffer status reporting for a set of logical channels (LCHs);
generate, for the set of LCHs, a buffer status report (BSR) in a predefined format; and
transmit the BSR to a radio access network (RAN).

2. The UE of claim 1, wherein the at least one processor is configured to cause the UE to receive a logical channel (LCH) configuration from the RAN, the LCH configuration indicating whether a particular logical channel is configured for extended reality (XR) traffic.

3. The UE of claim 1, wherein the at least one processor is configured to cause the UE to receive a BSR configuration from the RAN, the BSR configuration indicating an extended reality (XR)-specific condition applicable to the set of predefined LCHs, wherein to detect the trigger for buffer status reporting, the at least one processor is configured to cause the UE to determine whether a common BSR trigger is detected or the XR-specific condition is met, or both.

4. The UE of claim 3, wherein the BSR configuration indicates an XR-specific BSR timer having an associated timer value different than what is configured for non-XR buffer status reporting.

5. The UE of claim 1, wherein the set of LCHs is configured for extended reality (XR) traffic, wherein the predefined format comprises an XR-specific BSR format.

6. The UE of claim 1, wherein the BSR is identified by a reserved LCH identifier (ID).

7. The UE of claim 1, wherein the at least one processor is configured to cause the UE to:
receive an uplink (UL) grant;
determine whether the UL grant can accommodate all pending data available for transmission including data for the set of LCHs; and
cancel a triggered XR-specific BSR in response determining that the UL grant can accommodate all pending data available for transmission.

8. A method performed by a user equipment (UE), the method comprising:
detecting a trigger for buffer status reporting for a set of logical channels (LCHs);
generating, for the set of LCHs, a buffer status report (BSR) in a predefined format; and
transmitting the BSR to a radio access network (RAN).

9. The method of claim 8, further comprising receiving, from the RAN, a logical channel (LCH) configuration indicating whether a particular logical channel is configured for extended reality (XR) traffic.

10. The method of claim 8, further comprising receiving, from the RAN, a BSR configuration indicating an extended reality (XR)-specific condition applicable to the set of LCHs, and wherein detecting the trigger for buffer status reporting comprises determining whether a common BSR trigger is detected or the XR-specific condition is met, or both.

11. The method of claim 10, wherein the BSR configuration indicates an XR-specific BSR timer having an associated timer value different than what is configured for non-XR buffer status reporting.

12. The method of claim 8, wherein the set of LCHs is configured for extended reality (XR) traffic, wherein the predefined format comprises an XR-specific BSR format.

13. The method of claim 8, wherein the BSR is identified by a reserved LCH identifier (ID).

14. The method of claim 8, further comprising:
receiving an uplink (UL) grant;
determining whether the UL grant can accommodate all pending data available for transmission including data for the set of LCHs; and
cancelling a triggered XR-specific BSR in response determining that the UL grant can accommodate all pending data available for transmission.

15. A method performed by a base station, the method comprising:
transmitting a buffer status report (BSR) configuration to a user equipment (UE), the BSR configuration indicating an extended reality (XR)-specific condition applicable to a set of logical channels (LCHs); and
receiving a BSR indicative of the extended reality (XR)-specific condition being satisfied.

16. The method of claim 15, further comprising transmitting receiving a logical channel (LCH) configuration to the UE, the LCH configuration indicating whether a particular LCH is configured for XR traffic.

17. The method of claim 16, wherein the LCH configuration configures the set of predefined LCHs for XR traffic, and wherein the BSR uses an XR-specific BSR format.

18. The method of claim 15, wherein the BSR configuration indicates an XR-specific BSR timer having an associated timer value different than what is configured for non-XR buffer status reporting.

19. The method of claim 15, wherein the BSR is identified by a reserved logical channel ID.

20. A base station for wireless communication, comprising:
at least one memory; and
at least one processor coupled with the at least one memory and configured to cause the base station to:
transmit a buffer status report (BSR) configuration to a user equipment (UE), the BSR configuration indicating an extended reality (XR)-specific condition applicable to a set of logical channels (LCHs); and
receive a BSR indicative of the extended reality (XR)-specific condition being satisfied.
